(19) United States
(12) Patent Application Publication
(10) Pub. No.: US 2025/0375812 A1
(43) Pub. Date: Dec. 11, 2025

(54) PROCESS FOR PRODUCING A SINTERED LAYERED BODY BY CONTROLLING THE PARTICLE SIZE DISTRIBUTION OF A POWDER EMPLOYED

(71) Applicant: Heraeus Covantics North America LLC, Chandler, AZ (US)

(72) Inventors: Luke WALKER, Chandler, AZ (US); Matthew Joseph DONELON, Chandler, AZ (US); Samantha BAUMANN, Chandler, AZ (US)

(73) Assignee: Heraeus Covantics North America LLC, Chandler, AZ (US)

(21) Appl. No.: 19/226,745

(22) Filed: Jun. 3, 2025

Related U.S. Application Data
(60) Provisional application No. 63/656,158, filed on Jun. 5, 2024.

(51) Int. Cl. B22F 3/14

(52) U.S. Cl. CPC B22F 3/14; B22F 2301/052; B22F 2304/00

(57) ABSTRACT

One aspect is a process for producing a layered body. A first powder is introduced into an interior volume to obtain a first powder layer. The interior volume has a cross-sectional width of at least 200 mm, and is bordered by a die of carbon. The first powder is a mixture comprising a first constituent powder and a further constituent powder of different chemical compositions. The first powder layer is subjected to a heat, generated by a voltage, and to a pressure to obtain the layered body. The further constituent powder has a particle size distribution D=q(χ) of volume density q over particle size χ, such that D has a first local maximum α at particle size χ_{α} with volume density q_{α}, D has a second local maximum β at particle size χ_{β} with volume density q_{β}, χ_{α}>χ_{β}, and q_{α}/q_{β} is at least 1.

### CROSS-REFERENCE TO RELATED APPLICATION

This Non-Provisional Patent Application claims the benefit of the filing date of U.S. Provisional Patent Application Ser. No. 63/656,158, filed Jun. 5, 2024, which is incorporated herein by reference.

### DESCRIPTION

### Technical Field

The invention relates in general to sintering under pressure and with electrical current, often termed spark plasma sintering (SPS). A particular aspect of the invention relates to a spark plasma sintering process for obtaining a layered body, wherein the layered body is obtained using a first powder that is a mixture comprising a first constituent powder and a further constituent powder, wherein said further constituent powder has a specific particle size distribution. Further aspects of the invention relate to a layered body obtained by a spark plasma sintering process and the use of a further constituent powder with a specific particle size distribution for obtaining a layered body.

### Background

Sintering methods provide a route to forming bodies from powders through application of heat and pressure. In one method, often referred to as spark plasma sintering (SPS), heating is achieved using an electric current. The spark plasma sintering method in the state of the art has been applied to various materials. Existing literature focuses on small-scale systems, providing access to parts having physical extensions of up to around 150 mm. The question of preparing larger parts using SPS is assessed from a theoretical standpoint by Eugene A. Olevsky et al. in “Fundamental Aspects of Spark Plasma Sintering: I. Experimental Analysis of Scalability” (J. Am. Ceram. Soc., 95 [8], 2406 to 2413 (2012)) and “Fundamental Aspects of Spark Plasma Sintering: II. Experimental Analysis of Scalability” (J. Am. Ceram. Soc., 95 [8], 2414 to 2422 (2012)). A number of challenges and complications in relation to large-scale systems were identified. The layered body produced may be used in plasma processing chambers in the semiconductor manufacturing industry. Use of a body in such an industry requires a high-quality body that is, amongst other, etch resistant, strong, and having a very high purity. Use of a body in such an industry also requires that the layered body has a diameter of at least 200 mm. WO2022154936 A9 and WO2022133180 A1 disclose producing a layered body using spark plasma sintering.

### SUMMARY

An object of the present invention is to at least partially overcome at least one of the disadvantages encountered in the state of the art.

It is a further object of the invention to provide a process for producing a layered body, wherein said layered body has a diameter of at least 200 mm.

It is a further object of the invention to provide a process for producing a layered body, wherein said layered body has improved properties.

It is a further object of the invention to provide a process for producing a layered body, wherein said layered body has an increased strength.

It is a further object of the invention to provide a process for producing a layered body, wherein said layered body has an increased scratch resistance.

It is a further object of the invention to provide a process for producing a layered body, wherein said layered body has a decreased variation in density in the layered body.

It is a further object of the invention to provide a process for producing a layered body, wherein said layered body has a decreased defect rate.

It is a further object of the invention to provide a process for producing a layered body, wherein said layered body has an increased etch resistance.

It is a further object of the invention to provide a process for producing a layered body, wherein said layered body has a reduced porosity.

It is a further object of the invention to provide a process for producing a layered body, wherein said layered body has less unreacted starting powder.

It is a further object of the invention to provide a layered body, wherein said layered body has a diameter of at least 200 mm.

It is a further object of the invention to provide a layered body, wherein said layered body has improved properties (such as increased strength, increased scratch resistance, decreased variation in density, decreased defect rate, increased etch resistance, reduced porosity, less unreacted starting powder).

A contribution to at least partially fulfilling at least one of the above-mentioned objects is made by any of the embodiments of the invention.

An embodiment of the invention is a process for producing a layered body, comprising the following process steps:
a. introducing a first powder into an interior volume to obtain a first powder layer in the interior volume, wherein
   i. the interior volume
      A. has a cross-sectional width W of at least 200 mm, preferably at least 300 mm, more preferably at least 400 mm, and further preferably at least 500 mm, and
      B. is at least partially bordered by an interior surface of a die, wherein the die has at least one wall, and wherein said wall comprises carbon;
   ii. the first powder is a mixture comprising a first constituent powder and a further constituent powder, wherein the first constituent powder and the further constituent powder have different chemical compositions;
b. subjecting the first powder layer to a heat and a pressure to obtain the layered body, wherein
   i. the heat is generated by an electrical voltage applied across the die, the interior volume, or both, and
   ii. the layered body comprises a first layer;
      wherein
the further constituent powder, of the first powder, has a particle size distribution D=q(χ) of volume density q over particle size χ, such that
   I./ D has a first local maximum α at particle size χ_{α} with volume density q_{α},
   II./ D has a second local maximum β at particle size χ_{β} with volume density q₆₂ ,
   III./ χ_{α}>χ_{β}, and
   IV./ q_{α}/q_{β} is at least 1, preferably at least 1.4, more preferably at least 1.8, even more preferably at least 2.2, and further preferably at least 2.6.

This independent embodiment is a 1^{st} embodiment of the process for producing the layered body. In a preferred aspect of the 1^{st} embodiment of the process, the first powder is obtained by mixing the first constituent powder and the further continent powder. In this aspect it is preferred that the mixing is performed prior to introducing the first powder into the interior volume. In a preferred aspect of the 1^{st} embodiment of the process, the particle size distribution D=q(χ) of the first constituent powder, as given under points I./ to IV./ of said 1^{st} embodiment, is the particle size distribution of the first constituent powder prior to mixing the first constituent powder and the further constituent powder to obtain the first powder. In a preferred aspect of the 1^{st} embodiment of the process, q_{α}/q_{β} is in the range from 1 to 12, more preferably from 1.4 to 10, even more preferably from 1.8 to 8, further preferably from 2.2 to 6, and even further preferably from 2.6 to 4. In a preferred aspect of the 1^{st} embodiment of the process, the first local maximum α is a global maximum. In a preferred aspect of the 1^{st} embodiment of the process, the interior volume has a cross-sectional width W that is in the range from 200 to 650 mm, more preferably from 300 to 650 mm, even more preferably from 400 to 650 mm, and further preferably from 500 to 650 mm. In a preferred aspect of the 1^{st} embodiment of the process, the first constituent powder is zirconia. In another preferred aspect of the 1^{st} embodiment of the process, the further constituent powder is alumina.

In the following preferred embodiments, where reference is made to “the process”, this should be understood as referring to the process for producing a layered body.

In a preferred embodiment of the process, the first powder comprises at least one or all of the following: yttrium, aluminium, zirconium, magnesium, a combination of at least two thereof.

This preferred embodiment of the invention is a 2^{nd} embodiment of the process, that preferably depends on the 1^{st} embodiment of the process. Preferred combinations of at least two of the chemical elements in the 2^{nd} embodiment of the process include yttrium aluminium garnet, zirconia toughened alumina, a combination thereof. In a particularly preferred aspect of the 2^{nd} embodiment of the process, the first powder comprises yttria and alumina.

In a preferred embodiment of the process, the first powder comprises at least one oxide, preferably at least one oxide selected from the group consisting of yttria, alumina, zirconia, magnesia, a combination of at least two thereof.

This preferred embodiment of the invention is a 3^{rd} embodiment of the process, that preferably depends on any of the 1^{st} to 2^{nd} embodiments of the process. In a particularly preferred aspect of the 3^{rd} embodiment of the process, the first powder comprises yttria and alumina. In a preferred aspect of the 3^{rd} embodiment of the process, if the at least one oxide comprises and/or is zirconia, the zirconia is preferably partially stabilized zirconia, stabilized zirconia, or a combination thereof. In this aspect, partially stabilized zirconia is more preferred than stabilized zirconia.

In a preferred embodiment of the process, the first powder is a mixture of two constituent powders.

This preferred embodiment of the invention is a 4^{th} embodiment of the process, that preferably depends on any of the 1^{st} to 3^{rd} embodiments of the process. In a preferred aspect of the 4^{th} embodiment of the process, the two constituent powders are yttria powder and alumina powder.

In a preferred embodiment of the process, at least one or all of the following applies to the first powder:
a. comprises at least 25 mol-%, preferably at least 30 mol-%, and further preferably at least 35 mol-% yttria;
b. comprises at least 50 mol-%, more preferably at least 55 mol-%, and further preferably at least 60 mol-% alumina.

This preferred embodiment of the invention is a 5^{th} embodiment of the process, that preferably depends on any of the 1^{st} to 4^{th} embodiments of the process. In an aspect of the 5^{th} embodiment of the process, all possible combinations of the features a. and b. are preferred aspects of the embodiment. These combinations are e.g., a; b; a+b. In a preferred aspect of the 5^{th} embodiment of the process, feature a., the first powder comprises in the range from 28 to 48 mol-%, more preferably from 32 to 44 mol-%, and further preferably from 36 to 40 mol-% yttria. In a preferred aspect of the 5^{th} embodiment of the process, feature b., the first powder comprises in the range from 52 to 72 mol-%, more preferably from 56 to 68 mol-%, and further preferably from 60 to 64 mol-% alumina. In a particularly preferred aspect of the 5^{th} embodiment of the process, the first powder comprises yttria and alumina.

In a preferred embodiment of the process, at least one or all of the following applies to the first powder:
a. comprises in the range from 35.5 to 39.5 mol-%, preferably from 36.5 to 38.5 mol-%, and further preferably from 37.4 to 37.6 mol-% yttria;
b. comprises in the range from 60.5 to 64.5 mol-%, preferably from 61.5 to 63.5 mol-%, and further preferably from 62.4 to 62.6 mol-% alumina.

This preferred embodiment of the invention is a 6^{th} embodiment of the process, that preferably depends on any of the 1^{st} to 5^{th} embodiments of the process. In an aspect of the 6^{th} embodiment of the process, all possible combinations of the features a. and b. are preferred aspects of the embodiment. These combinations are e.g., a; b; a+b. In a preferred aspect of the 6^{th} embodiment of the process, the first powder is a stoichiometric powder mixture of 37.4 to 37.6 mol-% yttria and 62.4 and 62.6% mol alumina. The following ratio is particularly preferred: 37.5 mol-% yttria and 62.5 mol-% alumina. In the 6^{th} embodiment of the process, the combination of features a+b does not necessarily have to add up to 100 mol-%.

In a preferred embodiment of the process, the first constituent powder, of the first powder, has at least one or all of the following properties:
a. a d₁₀ particle size that is in the range from 1 to 7 μm, preferably from 1.5 to 6 μm, more preferably from 2 to 5.4 μm, even more preferably from 2.5 to 4.7 μm, and further preferably from 2.9 to 4.3 μm;
b. a d₅₀ particle size that is in the range from 2 to 14 μm, preferably from 3 to 12 μm, more preferably from 4 to 10 μm, even more preferably from 4.7 to 8 μm, and further preferably from 5.1 to 7.5 μm;
c. a d₉₀ particle size that is in the range from 3 to 20 μm, preferably from 5 to 18 μm, more preferably from 7 to 16 μm, even more preferably from 7.5 to 14 μm, and further preferably from 8 to 12 μm.

This preferred embodiment of the invention is a 7^{th} embodiment of the process, that preferably depends on any of the 1^{st} to 6^{th} embodiments of the process. In an aspect of the 7^{th} embodiment of the process, all possible combinations of the features a. to c. are preferred aspects of the embodiment. These combinations are e.g., a; b; c; a+b; a+c; b+c; a+b+c. The above values, given in at least one or all of the features a. to c. of the 7^{th} embodiment of the process, preferably apply after the first powder has been subjected to a heat treatment, such as calcination. In a preferred aspect of the 7^{th} embodiment of the process, the first constituent powder, of the first powder, is yttria.

In a preferred embodiment of the process, the first powder layer has a thickness such that the first layer, formed from the first powder layer, has a thickness that is less than or equal to 15 mm, preferably less than or equal to 10 mm, more preferably less than or equal to 8 mm, and further preferably less than or equal to 6 mm.

This preferred embodiment of the invention is an 8th embodiment of the process, that preferably depends on any of the 1^{st} to 7^{th} embodiments of the process.

In a preferred embodiment of the process, the first powder layer has a thickness such that the first layer, formed from the first powder layer, has a thickness in the range from 0.5 to 15 mm, preferably from 0.5 to 12 mm, more preferably from 2 to 10 mm, even more preferably from 3 to 8 mm, further preferably from 4 to 6 mm, and even further preferably from 4 to 5 mm.

This preferred embodiment of the invention is a 9^{th} embodiment of the process, that preferably depends on any of the 1^{st} to 8^{th} embodiments of the process.

In a preferred embodiment of the process, the process further comprises the step of introducing a further powder into the interior volume to obtain a further powder layer.

This preferred embodiment of the invention is a 10^{th} embodiment of the process, that preferably depends on any of the 1^{st} to 9^{th} embodiments of the process. In a preferred aspect of the 10^{th} embodiment of the process, the first powder layer and the further powder layer are in physical contact, e.g., touch each other. In a preferred aspect of the 10^{th} embodiment of the process, the further powder is introduced into the interior volume prior to subjecting the first powder layer to the heat and pressure. In this aspect, it is preferred to subject both the first powder layer and the further powder layer to the heat and the pressure, thereby leading to the layered body obtained, wherein the layered body comprises the first layer and a further layer. In a preferred aspect of the 10^{th} embodiment of the process, the further powder is introduced into the interior volume before, or after, the first powder layer has been obtained. In this aspect it is more preferred that the further powder is introduced into the interior volume after the first powder layer has been obtained. In an alternatively preferred aspect of the 10^{th} embodiment of the process, the further powder is introduced into the interior volume after the first powder layer has been subjected to the heat and pressure. In this alternatively preferred aspect, the further powder layer is subjected to a further heat and a further pressure. In this alternatively preferred aspect, the layered body is obtained, wherein the layered body comprises the first layer and a further layer.

In a preferred embodiment of the process, the further powder comprises aluminium, zirconium, or a combination thereof.

This preferred embodiment of the invention is an 11^{th} embodiment of the process, that preferably depends on the 10^{th} embodiment of the process. In the 11^{th} embodiment of the process, a preferred combination of aluminium and zirconium is zirconia toughened alumina. Here the zirconia is preferably partially stabilized, stabilized, or a combination thereof, with partially stabilized zirconia being particularly preferred.

In a preferred embodiment of the process, the further powder comprises at least one oxide, preferably at least one oxide selected from the group consisting of alumina, zirconia, a combination thereof.

This preferred embodiment of the invention is a 12^{th} embodiment of the process, that preferably depends on any of the 10^{th} to 11^{th} embodiments of the process. In a preferred aspect of the 12^{th} embodiment of the process, if the at least one oxide comprises and/or is zirconia, the zirconia is partially stabilized, stabilized, or a combination of at least two thereof. In this aspect, partially stabilized zirconia is more preferred than stabilized zirconia.

In a preferred embodiment of the process, the further powder is a mixture of at least two constituent powders, preferably alumina powder and zirconia powder.

This preferred embodiment of the invention is a 13^{th} embodiment of the process, that preferably depends on any of the 10^{th} to 12^{th} embodiments of the process.

In a preferred embodiment of the process, at least one or all of the following applies to the further powder:
a. comprises alumina, preferably in the range from 60 to 92.5 wt-%, more preferably from 66 to 89 wt-%, even more preferably from 71 to 84 wt-%, and further preferably from 75 to 79 wt-%, based on a total weight of the further powder;
b. comprises zirconia, preferably in the range from 7.5 to 40 wt-%, more preferably from 11 to 35 wt-%, even more preferably from 16 to 29 wt-%, and further preferably from 21 to 25 wt-%, based on a total weight of the further powder.

This preferred embodiment of the invention is a 14^{th} embodiment of the process, that preferably depends on any of the 10^{th} to 13^{th} embodiments of the process. In an aspect of the 14^{th} embodiment of the process, all possible combinations of the features a. and b. are preferred aspects of the embodiment. These combinations are e.g., a; b; a+b. In a particularly preferred aspect of the 14^{th} embodiment of the process, the further powder is a mixture comprising alumina powder and zirconia powder. In the 14^{th} embodiment of the process, the zirconia is preferably at least one of partially stabilized and stabilized zirconia, with partially stabilized zirconia being particularly preferred.

In a preferred embodiment of the process, the further powder is a mixture comprising a first constituent powder and a further constituent powder, and wherein the first constituent powder, of the further powder, has at least one or all of the following properties:
a. a d₁₀ particle size that is in the range from 0.01 to 0.4 μm, preferably from 0.04 to 0.35 μm, more preferably from 0.06 to 0.27 μm, even more preferably from 0.09 to 0.22 μm, and further preferably from 0.11 to 0.18 μm;
b. a d₅₀ particle size that is in the range from 0.01 to 3 μm, preferably from 0.1 to 1.5 μm, more preferably from 0.2 to 1 μm, even more preferably from 0.26 to 0.6 μm, and further preferably from 0.3 to 0.36 μm;
c. a d₉₀ particle size that is in the range from 0.3 to 10 μm, preferably from 0.4 to 7 μm, more preferably from 0.47 to 6 μm, even more preferably from 0.53 to 3 μm, and further preferably from 0.57 to 1 μm.

This preferred embodiment of the invention is a 15^{th} embodiment of the process, that preferably depends on any of the 10^{th} to 14^{th} embodiments of the process. In an aspect of the 15^{th} embodiment of the process, all possible combinations of the features a. to c. are preferred aspects of the embodiment. These combinations are e.g., a; b; c; a+b; a+c; b+c; a+b+c. The above values, given in at least one or all of the features a. to c. of the 15^{th} embodiment of the process, preferably apply after the further powder has been subjected to a heat treatment, such as calcination. In a preferred aspect of the 15^{th} embodiment of the process, the first constituent powder, of the further powder, is zirconia.

In a preferred embodiment of the process, the further powder is a mixture comprising a first constituent powder and a further constituent powder, and wherein the further constituent powder, of the further powder, has at least one or all of the following properties:
a. a d₁₀ particle size that is in the range from 0.01 to 0.3 μm, more preferably from 0.03 to 0.2 μm, and further preferably from 0.05 to 0.15 μm;
b. a d₅₀ particle size that is in the range from 0.01 to 1.5 μm, more preferably from 0.05 to 1.0 μm, and further preferably from 0.1 to 0.8 μm;
c. a d₉₀ particle size that is in the range from 0.01 to 6.0 μm, more preferably from 0.05 to 3.5 μm, and further preferably from 0.1 to 3.0 μm.

This preferred embodiment of the invention is a 16^{th} embodiment of the process, that preferably depends on any of the 10^{th} to 15^{th} embodiments of the process. In an aspect of the 16^{th} embodiment of the process, all possible combinations of the features a. to c. are preferred aspects of the embodiment. These combinations are e.g., a; b; c; a+b; a+c; b+c; a+b+c. The above values, given in at least one or all of the features a. to c. of the 16^{th} embodiment of the process, preferably apply before the further powder has been subjected to a heat treatment, such as calcination. In a preferred aspect of the 16^{th} embodiment of the process, the further constituent powder, of the further powder, is alumina.

In a preferred embodiment of the process, the further powder layer has a thickness such that the further layer, formed from the further powder layer, has a thickness in the range from 5 to 50 mm, preferably from 15 to 40 mm, further preferably from 20 to 35 mm, and even further preferably from 25 to 30 mm.

This preferred embodiment of the invention is a 17^{th} embodiment of the process, that preferably depends on any of the 10^{th} to 16^{th} embodiments of the process.

In a preferred embodiment of the process, one of the following applies:
a. the first powder is capable, under the application of heat and pressure, of forming a first oxide, preferably an oxide A;
b. the first powder is capable, under the application of heat and pressure, of forming a further oxide, preferably an oxide B.

This preferred embodiment of the invention is an 18^{th} embodiment of the process, that preferably depends on any of the 1^{st} to 17^{th} embodiments of the process. In an aspect of the 18^{th} embodiment of the process, feature a. is particularly preferred.

In a preferred embodiment of the process, one of the following applies:
a. the further powder is capable, under the application of heat and pressure, of forming the first oxide;
b. the further powder is capable, under the application of heat and pressure, of forming the further oxide.
c. the first powder and the further powder are capable, under the application of heat and pressure, of forming the first oxide;
d. the first powder and the further powder are capable, under the application of heat and pressure, of forming the further oxide;
e. the first powder is capable, under the application of heat and pressure, of forming the first oxide and the further powder is capable, under the application of heat and pressure, of forming the further oxide;
f. the first powder is capable, under the application of heat and pressure, of forming the further oxide and the further powder is capable, under the application of heat and pressure, of forming the first oxide.

This preferred embodiment of the invention is an 19^{th} embodiment of the process, that preferably depends on any of the 10^{th} to 18^{th} embodiments of the process. In an aspect of the 19^{th} embodiment of the process, the features e. and f. are particularly preferred, with feature e. most preferred. The first oxide and the further oxide are the same as described in the preceding 18th embodiment of the process. In a preferred aspect of the 19^{th} embodiment of the process, a first oxide is an oxide A. In another preferred aspect of the 19^{th} embodiment of the process, a further oxide is an oxide B.

In a preferred embodiment of the process, the first oxide is one of the following:
a. a cubic phase, preferably a cubic phase comprising yttrium, more preferably a cubic phase of yttrium aluminium oxide, and more preferably YAG, preferably with a composition comprising yttria and alumina in a ratio of 3:5;
b. an oxide comprising magnesium, more preferably an oxide comprising magnesium and aluminium, such as magnesium aluminate spinel (MgAl₂O₄);
c. a combination of yttria and zirconia, wherein the zirconia is preferably present in an amount that is in the range from 10 to 25 mol-%, more preferably from 15 to 25 mol-%, and further preferably from 18 to 25 mol-%; preferably from 10 to 23 mol-%, more preferably from 10 to 20 mol-%; preferably from 15 to 23 mol-%; the balance preferably comprising yttria; it is particularly preferred that the combination of yttria and zirconia are in the form of a crystalline solid solution;
d. YAG and at least one of the following: at least one perovskite, a monoclinic, alumina, yttria, a combination thereof, preferably YAG and at least one crystalline phase of YAP (yttrium aluminium perovskite), YAM (yttrium aluminium monoclinic), yttria, alumina, or a combination of at least two thereof; at least one or all of YAP, YAM, yttria, alumina are preferably present in amounts of less than 5% by volume; preferably at least one or all of the crystalline phases of YAG, YAP and YAM are polycrystalline.

This preferred embodiment of the invention is a 20^{th} embodiment of the process, that preferably depends on any of the 18^{th} to 19^{th} embodiments of the process. Feature a. of the 20^{th} embodiment of the process is particularly preferred. In this aspect it is preferred that the first oxide comprises less than 0.01 mol-% of at least one, preferably all, of the following: YAP, YAM, yttria.

In a preferred embodiment of the process, the further oxide comprises at least one or all of the following:
a. alumina;
b. zirconia, preferably stabilized zirconia and/or partially stabilized zirconia, with partially stabilized zirconia being particularly preferred.

This preferred embodiment of the invention is a 21^{st} embodiment of the process, that preferably depends on any of the 18^{th} to 20^{th} embodiments of the process. In an aspect of the 21^{st} embodiment of the process, all possible combinations of the features a. and b. are preferred aspects of the embodiment. These combinations are e.g., a; b; a+b. In a particularly preferred aspect of the 21^{st} embodiment of the process, the further oxide comprises alumina and zirconia. In this aspect it is preferred that the further oxide comprise at least two separate crystalline phases of zirconia and alumina, referred to herein as a composite oxide or particulate composite or a zirconia dispersion-toughened alumina (ZTA).

In a preferred embodiment of the process, during the step of subjecting the first powder layer, and preferably the further powder layer, if present, to the heat and the pressure, the temperature in the interior volume is in the range from 900 to 2000° C., preferably from 950 to 1900° C., more preferably from 1000 to 1800° C., and further preferably from 1050 to 1700° C.; preferably 1000 to 1700° C., more preferably from 1100 to 1700° C., even more preferably from 1200 to 1700° C., further preferably from 1300 to 1700° C., and even further preferably from 1400 to 1700° C.

This preferred embodiment of the invention is a 22^{nd} embodiment of the process, that preferably depends on any of the 1^{st} to 21^{st} embodiments of the process.

In a preferred embodiment of the process, during the step of subjecting the first powder layer, and preferably the further powder layer, if present, to the heat and the pressure, the first powder layer, and preferably the further powder layer, if present, is subjected to a pressure of at least 1 MPa, preferably at least 5 MPa, more preferably at least 10 MPa, further preferably at least 15 MPa; preferably from 1 to 100 MPa, more preferably from 5 to 60 MPa, even more preferably from 5 to 45 MPa, further preferably from 5 to 30 MPa, and even further preferably from 5 to 15 MPa; preferably from 10 to 60 MPa, more preferably from 10 to 45 MPa, even more preferably from 10 to 30 MPa, and further preferably from 10 to 15 MPa; preferably from 15 to 60 MPa, more preferably from 15 to 45 MPa, even more preferably from 15 to 30 MPa, and further preferably from 15 MPa to 20 MPa.

This preferred embodiment of the invention is a 23^{rd} embodiment of the process, that preferably depends on any of the 1^{st} to 22^{nd} embodiments of the process.

In a preferred embodiment of the process, the electrical voltage (applied across the die, the interior volume, or both) is in the range from 0.5 to 10 V, preferably from 1 to 8 V, more preferably from 1.5 to 7 V, and further preferably from 2 to 6 V.

This preferred embodiment of the invention is a 24^{th} embodiment of the process, that preferably depends on any of the 1^{st} to 23^{rd} embodiments of the process.

In a preferred embodiment of the process, the electrical voltage (applied across the die, the interior volume, or both) is obtained by providing an electrical current to a device comprising the interior volume, and wherein the electrical current is in the range from 1 to 100 kA, preferably from 5 to 90 kA, more preferably from 10 to 80 kA, even more preferably from 15 to 70 kA, and further preferably from 20 to 60 kA; alternatively, the electrical current may be more than 100 kA.

This preferred embodiment of the invention is a 25^{th} embodiment of the process, that preferably depends on any of the 1^{st} to 24^{th} embodiments of the process. In the 25^{th} embodiment of the process, the electrical current is preferably provided by an electrical power source connected to the device.

In a preferred embodiment of the process, the layered body has a diameter of at least 200 mm, preferably at least 300 mm, and more preferably at least 500 mm; the diameter might reach as high as 2000 mm or more; the diameter is preferably not more than 1500 mm, more preferably not more than 900 mm, even more preferably not more than 800 mm, further preferably not more than 700 mm, and even further preferably not more than 650 mm; the diameter is preferably in the range from more than 200 to 625 mm; more preferably from 300 to 625 mm, even more preferably from 400 to 625 mm, and further preferably from 500 to 625 mm.

This preferred embodiment of the invention is a 26^{th} embodiment of the process, that preferably depends on any of the 1^{st} to 25^{th} embodiments of the process.

In a preferred embodiment of the process, an electrical power flux applied is in the range from 0.05 to 1.6 W/mm², preferably from 0.1 to 1.3 W/mm², and further preferably from 0.3 to 1 W/mm², wherein said power flux is applied to at least one or all of the following: the die, the interior volume, the first powder layer, the further powder layer, if present, at least one punch, if present, or at least two thereof.

This preferred embodiment of the invention is a 27^{th} embodiment of the process, that preferably depends on any of the 1^{st} to 26^{th} embodiments of the process. In a preferred aspect of the 27^{th} embodiment of the process, the electrical power flux is in the range from 0.05 to 1 W/mm², more preferably from 0.1 to 0.7 W/mm², and further preferably from 0.3 to 0.5 W/mm² when the layered body, to be prepared, has a diameter in the range from >500 mm to 650 mm. In a preferred aspect of the 27^{th} embodiment of the process, the electrical power flux is in the range from >0.1 to 1.6 W/mm², more preferably from >0.3 to 1.3 W/mm², and further preferably from >0.5 to 1.0 W/mm² when the layered body, to be prepared, has a diameter in the range from 300 mm to 500 mm.

In a preferred embodiment of the process, the interior volume is bordered by the following:
a. a first punch interior surface of the first punch;
b. a second punch interior surface of the second punch; and
c. the interior surface of the die, and
   wherein
   I. the first punch and the second punch are adapted and arranged to apply the pressure to the first powder layer, and preferably the further powder layer, if present, in the interior volume during the step of subjecting the first powder layer, and preferably the further powder layer, if present, to the heat and the pressure,
   II. the pressure is applied along a compression axis, and
   III. an angle between the compression axis and the cross-sectional width W of the interior volume is in the range from 88° to 92°, preferably from 89° to 91°, and further preferably from 89.5° to 90.5°.

This preferred embodiment of the invention is a 28^{th} embodiment of the process, that preferably depends on any of the 1^{st} to 27^{th} embodiments of the process.

In a preferred embodiment of the process, the first powder is capable, under the application of heat and pressure, of forming at least one or all of the following:
a. an oxide A comprising at least 1 mol-% of an element of the 3^{rd} group (former group IIIB), preferably yttrium, and at least 1 mol-% of an element of the 13^{th} group (former group IIIA), preferably aluminium, wherein the mol-% is based on the oxygen in the oxide A; preferably, the oxide A is a cubic phase of yttrium aluminium oxide, more preferably YAG;
b. an oxide B comprising at least 1 mol-% of an element of the 4^{th} group (former group IVB), preferably zirconium, and at least 1 mol-% of an element of the 13^{th} group (former group IIIA), preferably aluminium, wherein the mol-% is based on the oxygen in the oxide B; preferably, the oxide B is ZTA.

This preferred embodiment of the invention is a 29^{th} embodiment of the process, that preferably depends on any of the 1^{st} to 28^{th} embodiments of the process. In an aspect of the 29^{th} embodiment of the process, all possible combinations of the features a. and b. are preferred aspects of the embodiment. These combinations are e.g., a; b; a+b. In the 29^{th} embodiment of the process, the groups refer to groups of the periodic table. Feature a. in the 29^{th} embodiment of the process is particularly preferred. In a preferred aspect of the 29^{th} embodiment of the process, an oxide A is an inorganic oxide. In a preferred aspect of the 29^{th} embodiment of the process, an oxide B is an inorganic oxide. In a preferred aspect of the 29^{th} embodiment of the process, feature a., the oxide A comprises at least 3 mol-%, more preferably at least 5 mol-%, and further preferably at least 7 mol-% of an element of the 3^{rd} group (former group IIIB). In a preferred aspect of the 29^{th} embodiment of the process, feature a., the oxide A comprises at least 3 mol-%, more preferably at least 5 mol-%, and further preferably at least 7 mol-% of an element of the 13^{th} group (former group IIIA). In a preferred aspect of the 29^{th} embodiment of the process, feature b., the oxide B comprises at least 3 mol-%, more preferably at least 5 mol-%, and further preferably at least 7 mol-% of an element of the 4^{th} group (former group IVB). In a preferred aspect of the 29^{th} embodiment of the process, feature b., the oxide B comprises at least 3 mol-%, more preferably at least 5 mol-%, and further preferably at least 7 mol-% of an element of the 13^{th} group (former group IIIA).

In a preferred embodiment of the process, the further powder is capable, under the application of heat and pressure, of forming at least one or all of the following:
a. an oxide A comprising at least 1 mol-% of an element of the 3^{rd} group (former group IIIB), preferably yttrium, and at least 1 mol-% of an element of the 13^{th} group (former group IIIA), preferably aluminium, wherein the mol-% is based on the oxygen in the oxide A; preferably, the oxide A is a cubic phase of yttrium aluminium oxide, more preferably YAG;
b. an oxide B comprising at least 1 mol-% of an element of the 4^{th} group (former group IVB), preferably zirconium, and at least 1 mol-% of an element of the 13^{th} group (former group IIIA), preferably aluminium, wherein the mol-% is based on the oxygen in the oxide B; preferably, the oxide B is ZTA.

This preferred embodiment of the invention is a 30^{th} embodiment of the process, that preferably depends on any of the 10^{th} to 29^{th} embodiments of the process. In an aspect of the 30^{th} embodiment of the process, all possible combinations of the features a. and b. are preferred aspects of the embodiment. These combinations are e.g., a; b; a+b. In the 30^{th} embodiment of the process, the groups refer to groups of the periodic table. Feature b. in the 30^{th} embodiment of the process is particularly preferred. In a preferred aspect of the 30^{th} embodiment of the process, an oxide A is an inorganic oxide. In a preferred aspect of the 30^{th} embodiment of the process, an oxide B is an inorganic oxide. In a preferred aspect of the 30^{th} embodiment of the process, feature a., the oxide A comprises at least 3 mol-%, more preferably at least 5 mol-%, and further preferably at least 7 mol-% of an element of the 3^{rd} group (former group IIIB). In a preferred aspect of the 30^{th} embodiment of the process, feature a., the oxide A comprises at least 3 mol-%, more preferably at least 5 mol-%, and further preferably at least 7 mol-% of an element of the 13^{th} group (former group IIIA). In a preferred aspect of the 30^{th} embodiment of the process, feature b., the oxide B comprises at least 3 mol-%, more preferably at least 5 mol-%, and further preferably at least 7 mol-% of an element of the 4^{th} group (former group IVB). In a preferred aspect of the 30^{th} embodiment of the process, feature b., the oxide B comprises at least 3 mol-%, more preferably at least 5 mol-%, and further preferably at least 7 mol-% of an element of the 13^{th} group (former group IIIA).

In a preferred embodiment of the process, χ_{α} is in the range from 2 to 9 μm, preferably from 3 to 7 μm, more preferably from 3.4 to 6.6 μm, even more preferably from 3.8 to 6.2 μm, and further preferably from 4 to 5.8 μm.

This preferred embodiment of the invention is a 31^{st} embodiment of the process, that preferably depends on any of the 1^{st} to 30^{th} embodiments of the process.

In a preferred embodiment of the process, q_{α} is in the range from 0.025 to 0.12, preferably from 0.035 to 0.1, more preferably from 0.04 to 0.08, even more preferably from 0.045 to 0.07, and further preferably from 0.05 to 0.065, wherein q_{α} is larger than 0.

This preferred embodiment of the invention is a 32^{nd} embodiment of the process, that preferably depends on any of the 1^{st} to 31^{st} embodiments of the process. In a particularly preferred aspect of the 32^{nd} embodiment of the process, q_{α} is in the range from 0.035 to 0.12, preferably from 0.035 to 0.1, more preferably from 0.04 to 0.08, and further preferably from 0.045 to 0.07.

In a preferred embodiment of the process, D=q(χ) is a multimodal particle size distribution comprising at least two modes, preferably a bimodal particle size distribution, alternatively and more preferably a trimodal particle size distribution.

This preferred embodiment of the invention is a 33^{rd} embodiment of the process, that preferably depends on any of the 1^{st} to 32^{nd} embodiments of the process. In a preferred aspect of the 33^{rd} embodiment of the process, D has at least two modes, more preferably at least three modes.

In a preferred embodiment of the process, at least one or all of the following applies:
a. χ_{β} is less than or equal to 0.8 μm, preferably less than or equal to 0.6 μm, more preferably less than or equal to 0.5 μm, and further preferably less than or equal to 0.4 μm, and wherein χ_{β} is larger than 0;
b. q_{β} is less than or equal to 0.045, preferably less than or equal to 0.035, more preferably less than or equal to 0.03, even more preferably less than or equal to 0.026, and further preferably less than or equal to 0.022, wherein q_{β} is larger than 0.

This preferred embodiment of the invention is a 34^{th} embodiment of the process, that preferably depends on any of the 1^{st} to 33^{rd} embodiments of the process. In an aspect of the 34^{th} embodiment of the process, all possible combinations of the features a. and b. are preferred aspects of the embodiment. These combinations are e.g., a; b; a+b. In a preferred aspect of the 34^{th} embodiment of the process, feature a., χ_{β} is in the range from 0.01 to 0.8 μm, more preferably from 0.05 to 0.6 μm, even more preferably from 0.1 to 0.5 μm, and further preferably from 0.2 to 0.4 μm. In a preferred aspect of the 34^{th} embodiment of the process, feature b., q_{β} is in the range from 10⁻⁴ to 0.045, more preferably from 0.001 to 0.035, even more preferably from 0.005 to 0.03, further preferably from 0.008 to 0.026, and even further preferably from 0.01 to 0.022. In a preferred aspect of the 34^{th} embodiment of the process, if the further constituent powder (of the first powder) has at least feature b., then the values of q_{α} and q_{β} are subject to the limitation that q_{α}/q_{β} is at least 1. In a particularly preferred aspect of the 34^{th} embodiment of the process, feature b., q_{β} is less than 0.35, more preferably less than or equal to 0.03, and further preferably less than or equal to 0.025.

In a preferred embodiment of the process, the particle size distribution D=q(χ) has a third local maximum γ at particle size χ_{γ} with volume density q_{γ}, with χ_{γ}>χ_{β}, and preferably χ_{α}>χ_{γ}.

This preferred embodiment of the invention is a 35^{th} embodiment of the process, that preferably depends on any of the 1^{st} to 34^{th} embodiments of the process.

In a preferred embodiment of the process, at least one or all of the following applies:
a. q_{α}/q_{γ} is at least at least 1, preferably at least 1.2, more preferably at least 1.4, even more preferably at least 1.5, and further preferably at least 1.6;
b. q_{γ}/q_{β} is at least 1, preferably at least 1.2, more preferably at least 1.4, even more preferably at least 1.5, and further preferably at least 1.6.

This preferred embodiment of the invention is a 36^{th} embodiment of the process, that preferably depends on the 35^{th} embodiment of the process. In an aspect of the 36^{th} embodiment of the process, all possible combinations of the features a. and b. are preferred aspects of the embodiment. These combinations are e.g., a; b; a+b. In a preferred aspect of the 36^{th} embodiment of the process, feature a., q_{α}/q_{γ} is in the range from 1 to 10, more preferably from 1.2 to 8, even more preferably from 1.4 to 6, further preferably from 1.5 to 5, and even further preferably from 1.6 to 4. In a preferred aspect of the 36^{th} embodiment of the process, feature b., q_{γ}/q_{β} is in the range from 1 to 6, more preferably from 1.2 to 5, even more preferably from 1.4 to 4, further preferably from 1.5 to 3, and even further preferably from 1.6 to 2.5.

In a preferred embodiment of the process, χ_{β}<χ_{γ}<χ_{α} and q_{β}<q_{γ}<q_{α}.

This preferred embodiment of the invention is a 37^{th} embodiment of the process, that preferably depends on any of the 35^{th} to 36^{th} embodiments of the process.

In a preferred embodiment of the process, at least one or all of the following applies:
a. χ_{γ} is in the range from 0.6 to 2 μm, preferably from 0.7 to 1.7 μm, more preferably from 0.8 to 1.5 μm, and further preferably from 0.9 to 1.3 μm;
b. q_{γ} is in the range from 0.016 to 0.042, preferably from 0.02 to 0.038, and more preferably from 0.024 to 0.036.

This preferred embodiment of the invention is a 38^{th} embodiment of the process, that preferably depends on any of the 35^{th} to 37^{th} embodiments of the process. In an aspect of the 38^{th} embodiment of the process, all possible combinations of the features a. and b. are preferred aspects of the embodiment. These combinations are e.g., a; b; a+b. In a preferred aspect of the 38^{th} embodiment of the process, if the further constituent powder (of the first powder) has at least feature b., then the values of q_{α} and q_{γ} are subject to the limitation that q_{α}/q_{γ} is at least 1. In another preferred aspect of the 38^{th} embodiment of the process, if the further constituent powder of the first powder) has at least feature b., then the values of q_{β} and q_{γ} are subject to the limitation that q_{γ}/q_{β} is at least 1.

In a preferred embodiment of the process, the further constituent powder, of the first powder, has a specific surface area that is in the range from 8 to 20 m²/g, preferably from 8 to 18 m²/g, more preferably from 10 to 18 m²/g, even more preferably from 10 to 16 m²/g, and further preferably from 11 to 14 m²/g.

This preferred embodiment of the invention is a 39^{th} embodiment of the process, that preferably depends on any of the 1^{st} to 38^{th} embodiments of the process.

In a preferred embodiment of the process, the further constituent powder, of the first powder, is an oxide of a group 13 (formerly group 3A) element, preferably aluminium.

This preferred embodiment of the invention is a 40^{th} embodiment of the process, that preferably depends on any of the 1^{st} to 39^{th} embodiments of the process.

In a preferred embodiment of the process, the first constituent powder, of the first powder, is an oxide of an element selected from group 3 (formerly IIIB), preferably yttrium or group 4 (formerly IVB), preferably zirconium.

This preferred embodiment of the invention is a 41^{st} embodiment of the process, that preferably depends on any of the 1^{st} to 40^{th} embodiments of the process. In a particularly preferred aspect of the 41^{st} embodiment of the process, the first constituent powder (of the first powder) is an oxide of an element selected from group 3 (formerly IIIB), more preferably yttrium.

In a preferred embodiment of the process, at least one or all of the following applies:
a. the first constituent powder, of the first powder, has a purity of at least 95%, preferably at least 97%, more preferably at least 99%, even more preferably at least 99.99%, further preferably at least 99.999%, and even further preferably at least 99.9999%;
b. the further constituent powder, of the first powder, has a purity of at least 95%, preferably at least 97%, more preferably at least 99%, even more preferably at least 99.99%, further preferably at least 99.999%, and even further preferably at least 99.9999%;
c. the first powder has a purity of at least 95%, preferably at least 97%, more preferably at least 99%, even more preferably at least 99.99%, further preferably at least 99.999%, and even further preferably at least 99.9999%.

This preferred embodiment of the invention is a 42^{nd} embodiment of the process, that preferably depends on any of the 1^{st} to 41^{st} embodiments of the process. In an aspect of the 42^{nd} embodiment of the process, all possible combinations of the features a. to c. are preferred aspects of the embodiment. These combinations are e.g., a; b; c; a+b; a+c; b+c; a+b+c.

In a preferred embodiment of the process, the first constituent powder, of the first powder, has a particle size distribution E=r(χ) of volume density r over particle size χ, and wherein E has a global maximum δ at particle size χ_{δ} with volume density r_{δ}, and wherein at least one or all of the following applies:
a. χ_{δ} is in the range from 3 to 9 μm, preferably from 4.5 to 7.5 μm, more preferably from 5 to 6.8 μm, and further preferably from 5.5 to 6.3 μm;
b. r_{δ} is in the range from 0.05 to 0.22, preferably from 0.08 to 0.18, and more preferably from 0.11 to 0.15;
c. E is monomodal.

This preferred embodiment of the invention is a 43^{rd} embodiment of the process, that preferably depends on any of the 1^{st} to 42^{nd} embodiments of the process. In an aspect of the 43^{rd} embodiment of the process, all possible combinations of the features a. to c. are preferred aspects of the embodiment. These combinations are e.g., a; b; c; a+b; a+c; b+c; a+b+c. In a preferred aspect of the 43^{rd} embodiment of the process, the first powder is obtained by mixing the first constituent powder and the further constituent powder. In this aspect it is preferred that the mixing is performed prior to introducing the first powder into the interior volume. In a preferred aspect of the 43^{rd} embodiment of the process, at least one or all of the features a. to c. apply prior to mixing the first constituent powder and the further constituent powder to obtain the first powder.

In a preferred embodiment of the process, prior to introducing the first powder into the interior volume, the process comprises a step of mixing the first constituent powder and the further constituent powder to obtain the first powder.

This preferred embodiment of the invention is a 44^{th} embodiment of the process, that preferably depends on any of the 1^{st} to 43^{rd} embodiments of the process.

In a preferred embodiment of the process, prior to introducing the first powder into the interior volume, the first powder is subjected to a heat treatment.

This preferred embodiment of the invention is a 45^{th} embodiment of the process, that preferably depends on any of the 1^{st} to 44^{th} embodiments of the process. In a preferred aspect of the 45^{th} embodiment of the process, the heat treatment is performed after mixing the first constituent powder and the further constituent powder to obtain the first powder.

In a preferred embodiment of the process, the temperature of the heat treatment, that the first powder is subjected to, is in the range from 680 to 950° C., preferably from 740 to 900° C., and more preferably from 780 to 870° C.

This preferred embodiment of the invention is a 46^{th} embodiment of the process, that preferably depends on the 45^{th} embodiment of the process.

In a preferred embodiment of the process, the first powder has a specific surface area that is in the range from 3.5 to 12.5 m²/g, preferably from 3.75 to 10 m²/g, more preferably from 4 to 8 m²/g, even more preferably from 4.25 to 6.5 m²/g, and further preferably from 4.5 to 6.5 m²/g.

This preferred embodiment of the invention is a 47^{th} embodiment of the process, that preferably depends on any of the 1^{st} to 46^{th} embodiments of the process. In a preferred aspect of the 47^{th} embodiment of the process, the first powder has said specific surface area after being subjected to a heat treatment.

In a preferred embodiment of the process, the first layer of the layered body has a thickness that is less than or equal to 15 mm, preferably less than or equal to 10 mm, more preferably less than or equal to 8 mm, and further preferably less than or equal to 6 mm.

This preferred embodiment of the invention is a 48^{th} embodiment of the process, that preferably depends on any of the 1^{st} to 47^{th} embodiments of the process. In a preferred aspect of the 48^{th} embodiment of the process, the first layer of the layered body has a thickness in the range from 1 to 15 mm, more preferably from 2 to 10 mm, even more preferably from 3 to 8 mm, and further preferably from 4 to 6 mm.

Preferred embodiments of the process, and preferred aspects of these embodiments, that pertain to the first powder preferably also apply to the first powder layer. Preferred embodiments of the process, and preferred aspects of these embodiments, that pertain to the first powder layer preferably also apply to the first powder. Preferred embodiments of the process, and preferred aspects of these embodiments, that pertain to the further powder preferably also apply to the further powder layer. Preferred embodiments of the process, and preferred aspects of these embodiments, that pertain to the further powder layer preferably also apply to the further powder.

An embodiment of the invention is a layered body comprising a first layer, preferably a layered body obtainable by a process, according to the invention, for obtaining a layered body, more preferably obtainable by the process according to any of the 1^{st} to 48^{th} embodiments of said process. This embodiment is a 1^{st} embodiment of the layered body.

In a preferred embodiment of the layered body, the first layer comprises yttrium, aluminium, zirconium, magnesium, or a combination of at least two thereof.

This preferred embodiment of the invention is a 2^{nd} embodiment of the layered body, that preferably depends on the 1^{st} embodiment of the layered body. Preferred combinations of at least two of the chemical elements in the 2^{nd} embodiment of the layered body include yttrium aluminium garnet, zirconia toughened alumina, a combination thereof. In a particularly preferred aspect of the 2^{nd} embodiment of the layered body, the first layer comprises yttria and alumina.

In a preferred embodiment of the layered body, the first layer comprises at least one oxide, preferably at least one oxide selected from the group consisting of yttria, alumina, zirconia, magnesia, a combination of at least two thereof.

This preferred embodiment of the invention is a 3^{rd} embodiment of the layered body, that preferably depends on any of the 1^{st} to 2^{nd} embodiments of the layered body. In a particularly preferred aspect of the 3^{rd} embodiment of the layered body, the first layer comprises yttria and alumina. In a preferred aspect of the 3^{rd} embodiment of the layered body, if the at least one oxide comprises and/or is zirconia, the zirconia is preferably partially stabilized zirconia, stabilized zirconia, or a combination thereof. In this aspect, partially stabilized zirconia is more preferred than stabilized zirconia.

In a preferred embodiment of the layered body, at least one or all of the following applies to the first layer:
a. comprises at least 25 mol-%, preferably at least 30 mol-%, and further preferably at least 35 mol-%, yttria;
b. comprises at least 50 mol-%, more preferably at least 55 mol-%, and further preferably at least 60 mol-%, alumina.

This preferred embodiment of the invention is a 4^{th} embodiment of the layered body, that preferably depends on any of the 1^{st} to 3^{rd} embodiments of the layered body. In an aspect of the 4^{th} embodiment of the layered body, all possible combinations of the features a. and b. are preferred aspects of the embodiment. These combinations are e.g., a; b; a+b. In a preferred aspect of the 4^{th} embodiment of the layered body, feature a., the first layer comprises in the range from 28 to 48 mol-%, more preferably from 32 to 44 mol-%, and further preferably from 36 to 40 mol-% yttria. In a preferred aspect of the 4^{th} embodiment of the layered body, feature b., the first layer comprises in the range from 52 to 72 mol-%, more preferably from 56 to 68 mol-%, and further preferably from 60 to 64 mol-% alumina. In a particularly preferred aspect of the 4^{th} embodiment of the layered body, the first layer comprises yttria and alumina.

In a preferred embodiment of the layered body, at least one or all of the following applies to the first layer:
a. comprises in the range from 35.5 to 39.5 mol-%, preferably from 36.5 to 38.5 mol-%, and further preferably from 37.4 to 37.6 mol-%, yttria;
b. comprises in the range from 60.5 to 64.5 mol-%, preferably from 61.5 to 63.5 mol-%, and further preferably from 62.4 to 62.6 mol-%, alumina.

This preferred embodiment of the invention is a 5^{th} embodiment of the layered body, that preferably depends on any of the 1^{st} to 4^{th} embodiments of the layered body. In an aspect of the 5^{th} embodiment of the layered body, all possible combinations of the features a. and b. are preferred aspects of the embodiment. These combinations are e.g., a; b; a+b. In a preferred aspect of the 5^{th} embodiment of the layered body, the first layer comprises in the range from 37.4 to 37.6 mol-% yttria and in the range from 62.4 and 62.6% mol alumina. The following ratio is particularly preferred: 37.5 mol-% yttria and 62.5 mol-% alumina. In the 5^{th} embodiment of the layered body, the combination of features a+b does not necessarily have to add up to 100 mol-%.

In a preferred embodiment of the layered body, the first layer comprises at least one or all of the following:
a. an oxide A comprising at least 1 mol-% of an element of the 3^{rd} group (former group IIIB), preferably yttrium, and at least 1 mol-% of an element of the 13^{th} group (former group IIIA), preferably aluminium, wherein the mol-% is based on the oxygen in the oxide A; preferably, the oxide A is a cubic phase of yttrium aluminium oxide, more preferably YAG;
b. an oxide B comprising at least 1 mol-% of an element of the 4^{th} group (former group IVB), preferably zirconium, and at least 1 mol-% of an element of the 13^{th} group (former group IIIA), preferably aluminium, wherein the mol-% is based on the oxygen in the oxide B; preferably, the oxide B is ZTA.

This preferred embodiment of the invention is a 6^{th} embodiment of the layered body, that preferably depends on any of the 1^{st} to 5^{th} embodiments of the layered body. In an aspect of the 6^{th} embodiment of the layered body, all possible combinations of the features a. and b. are preferred aspects of the embodiment. These combinations are e.g., a; b; a+b. In the 6^{th} embodiment of the layered body, the groups refer to groups of the periodic table. Feature a. in the 6^{th} embodiment of the layered body is particularly preferred. In a preferred aspect of the 6^{th} embodiment of the process, an oxide A is an inorganic oxide. In a preferred aspect of the 6^{th} embodiment of the process, an oxide B is an inorganic oxide. In a preferred aspect of the 6^{th} embodiment of the layered body, feature a., the oxide A comprises at least 3 mol-%, more preferably at least 5 mol-%, and further preferably at least 7 mol-% of an element of the 3^{rd} group (former group IIIB). In a preferred aspect of the 6^{th} embodiment of the layered body, feature a., the oxide A comprises at least 3 mol-%, more preferably at least 5 mol-%, and further preferably at least 7 mol-% of an element of the 13^{th} group (former group IIIA). In a preferred aspect of the 6^{th} embodiment of the layered body, feature b., the oxide B comprises at least 3 mol-%, more preferably at least 5 mol-%, and further preferably at least 7 mol-% of an element of the 4^{th} group (former group IVB). In a preferred aspect of the 6^{th} embodiment of the layered body, feature b., the oxide B comprises at least 3 mol-%, more preferably at least 5 mol-%, and further preferably at least 7 mol-% of an element of the 13^{th} group (former group IIIA).

In a preferred embodiment of the layered body, a thickness of the first layer is less than or equal to 15 mm, preferably less than or equal to 10 mm, more preferably less than or equal to 8 mm, and further preferably less than or equal to 6 mm.

This preferred embodiment of the invention is a 7^{th} embodiment of the layered body, that preferably depends on any of the 1^{st} to 6^{th} embodiments of the layered body. In a preferred aspect of the 7^{th} embodiment of the layered body, the first layer of the layered body has a thickness that is in the range from 0.5 to 15 mm, more preferably from 0.5 to 12 mm, even more preferably from 2 to 10 mm, further preferably from 3 to 8 mm, further preferably from 4 to 6 mm, and even further preferably from 4 to 5 mm.

In a preferred embodiment of the layered body, the layered body comprises a further layer.

This preferred embodiment of the invention is an 8^{th} embodiment of the layered body, that preferably depends on any of the 1^{st} to 7^{th} embodiments of the layered body.

In a preferred embodiment of the layered body, the further layer comprises aluminium, zirconium, or a combination thereof.

This preferred embodiment of the invention is a 9^{th} embodiment of the layered body, that preferably depends on the 8^{th} embodiment of the layered body. In the 9^{th} embodiment of the layered body, a preferred combination of aluminium and zirconium is zirconia toughened alumina. Here the zirconia is preferably partially stabilized, stabilized, or a combination of at least two thereof, with partially stabilized zirconia being particularly preferred.

In a preferred embodiment of the layered body, the further layer comprises at least one oxide, preferably at least one oxide selected from the group consisting of alumina, zirconia, a combination thereof.

This preferred embodiment of the invention is a 10^{th} embodiment of the layered body, that preferably depends on any of the 8^{th} to 9^{th} embodiments of the layered body. In a preferred aspect of the 10^{th} embodiment of the layered body, if the at least one oxide comprises and/or is zirconia, the zirconia is partially stabilized, stabilized, or a combination of at least two thereof. In this aspect, partially stabilized zirconia is more preferred than stabilized zirconia.

In a preferred embodiment of the layered body, at least one or all of the following applies to the further layer:
a. comprises alumina in the range from 70 to 97 vol-%, preferably from 75 to 95 vol-%, and further preferably from 80 to 92 vol-%; preferably from 70 to 90 vol-%, more preferably from 75 to 95 vol-%, even more preferably from 80 to 90 vol-%; preferably from 75 to 86 vol-%, more preferably from 80 vol-% to 86 vol-%, based on a total volume of a further layer;
b. comprises zirconia in the range from 3 to 30 vol-%, preferably in the range from 5 to 25 vol-%, and further preferably in the range from 8 to 20 vol-%; preferably from 10 to 30 vol-% more preferably from 10 to 25 vol-%, more preferably from 10 to 20 vol-%; preferably from 14 to 25 vol-%, more preferably from 20 to 25 vol-%; preferably from 14 to 20 vol-%, based on a total volume of a further layer.

This preferred embodiment of the invention is an 11^{th} embodiment of the layered body, that preferably depends on any of the 8^{th} to 10^{th} embodiments of the layered body. In an aspect of the 11^{th} embodiment of the layered body, all possible combinations of the features a. and b. are preferred aspects of the embodiment. These combinations are e.g., a; b; a+b. In a preferred aspect of the 11^{th} embodiment of the layered body, it is preferred that the further layer comprises both alumina and zirconia. In this aspect it is preferred that the further layer comprises in the range from 80 to 92 vol-% alumina and in the range from 8 to 20 vol-% zirconia.

In a preferred embodiment of the layered body, the further layer comprises at least one or all of the following:
a. an oxide A comprising at least 1 mol-% of an element of the 3^{rd} group (former group IIIB), preferably yttrium, and at least 1 mol-% of an element of the 13^{th} group (former group IIIA), preferably aluminium, wherein the mol-% is based on the oxygen in the oxide A; preferably, the oxide A is a cubic phase of yttrium aluminium oxide, more preferably YAG;
b. an oxide B comprising at least 1 mol-% of an element of the 4^{th} group (former group IVB), preferably zirconium, and at least 1 mol-% of an element of the 13^{th} group (former group IIIA), preferably aluminium, wherein the mol-% is based on the oxygen in the oxide B; preferably, the oxide B is ZTA.

This preferred embodiment of the invention is a 12^{th} embodiment of the layered body, that preferably depends on any of the 8^{th} to 11^{th} embodiments of the layered body. In an aspect of the 12^{th} embodiment of the layered body, all possible combinations of the features a. and b. are preferred aspects of the embodiment. These combinations are e.g., a; b; a+b. In the 12^{th} embodiment of the layered body, the groups refer to groups of the periodic table. Feature b. in the 12^{th} embodiment of the layered body is particularly preferred. In a preferred aspect of the 12^{th} embodiment of the process, an oxide A is an inorganic oxide. In a preferred aspect of the 12^{th} embodiment of the process, an oxide B is an inorganic oxide. In a preferred aspect of the 12^{th} embodiment of the layered body, feature a., the oxide A comprises at least 3 mol-%, more preferably at least 5 mol-%, and further preferably at least 7 mol-% of an element of the 3^{rd} group (former group IIIB). In a preferred aspect of the 12^{th} embodiment of the layered body, feature a., the oxide A comprises at least 3 mol-%, more preferably at least 5 mol-%, and further preferably at least 7 mol-% of an element of the 13^{th} group (former group IIIA). In a preferred aspect of the 12^{th} embodiment of the layered body, feature b., the oxide B comprises at least 3 mol-%, more preferably at least 5 mol-%, and further preferably at least 7 mol-% of an element of the 4^{th} group (former group IVB). In a preferred aspect of the 12^{th} embodiment of the layered body, feature b., the oxide B comprises at least 3 mol-%, more preferably at least 5 mol-%, and further preferably at least 7 mol-% of an element of the 13^{th} group (former group IIIA).

In a preferred embodiment of the layered body, at least one or all of the following applies:
a. a thickness of the further layer is in the range from 1.5 to 15 times, preferably from 2 to 10 times, and more preferably from 3.5 to 8 times, larger than a thickness of the first layer;
b. a thickness of the further layer is in the range from 5 to 50 mm, preferably in the range from 15 to 35 mm, and further preferably in the range from 20 to 30 mm;

This preferred embodiment of the invention is a 13^{th} embodiment of the layered body, that preferably depends on any of the 8^{th} to 12^{th} embodiments of the layered body. In an aspect of the 13^{th} embodiment of the layered body, all possible combinations of the features a. and b. are preferred aspects of the embodiment. These combinations are e.g., a; b; a+b.

In a preferred embodiment of the layered body, one of the following applies:
a. the first layer comprises the first oxide, wherein the first oxide is preferably an oxide A;
b. the first layer comprises the further oxide, wherein the further oxide is preferably an oxide B.

This preferred embodiment of the invention is a 14^{th} embodiment of the layered body, that preferably depends on any of the 1^{st} to 13^{th} embodiments of the layered body. In an aspect of the 14^{th} embodiment of the process, feature a. is particularly preferred.

In a preferred embodiment of the layered body, one of the following applies:
a. the further layer comprises the first oxide;
b. the further layer comprises the further oxide;
c. the first layer and the further layer comprise the first oxide;
d. the first layer and the further layer comprise the further oxide;
e. the first layer comprises the first oxide and the further layer comprises the further oxide;
f. the first layer comprises the further oxide and the further layer comprises the first oxide.

This preferred embodiment of the invention is a 15^{th} embodiment of the layered body, that preferably depends on any of the 8^{th} to 14^{th} embodiments of the layered body. In a preferred aspect of the 15^{th} embodiment layered body, the features e. and f. are particularly preferred, with feature e. most preferred. The first oxide and the further oxide is the same as described in the previous 14^{th} embodiment of the layered body. In a preferred aspect of the 15^{th} embodiment of the layered body, the first oxide is an oxide A. In another preferred aspect of the 15^{th} embodiment of the layered body, the further oxide is an oxide B.

In a preferred embodiment of the layered body, the first oxide is one of the following:
a. a cubic phase, preferably a cubic phase comprising yttrium, more preferably a cubic phase of yttrium aluminium oxide, and more preferably YAG, preferably with a composition comprising yttria and alumina in a ratio of 3:5;
b. an oxide comprising magnesium, more preferably an oxide comprising magnesium and aluminium, such as magnesium aluminate spinel (MgAl₂O₄);
c. a combination of yttria and zirconia, wherein the zirconia is preferably present in an amount that is in the range from 10 to 25 mol-%, more preferably from 15 to 25 mol-%, and further preferably from 18 to 25 mol-%; preferably from 10 to 23 mol-%, more preferably from 10 to 20 mol-%; preferably from 15 to 23 mol-%; the balance preferably comprising yttria; it is particularly preferred that the combination of yttria and zirconia are in the form of a crystalline solid solution
d. YAG and at least one of the following: at least one perovskite, a monoclinic, alumina, yttria, a combination thereof, preferably YAG and at least one crystalline phase of YAP (yttrium aluminium perovskite), YAM (yttrium aluminium monoclinic), yttria, alumina, or a combination of at least two thereof; at least one or all of YAP, YAM, yttria, alumina are preferably present in amounts of less than 5% by volume; preferably at least one or all of the crystalline phases of YAG, YAP and YAM are polycrystalline.

This preferred embodiment of the invention is a 16^{th} embodiment of the layered body, that preferably depends on any of the 14^{th} to 15^{th} embodiments of the layered body. Feature a. of the 16^{th} embodiment of the layered body is particularly preferred. In this aspect it is preferred that the first oxide comprises less than 0.01 mol-% of at least one, preferably all, of the following: YAP, YAM, yttria.

In a preferred embodiment of the layered body, the further oxide comprises at least one or all of the following:
a. alumina;
b. zirconia, preferably stabilized zirconia and/or partially stabilized zirconia, with partially stabilized zirconia being particularly preferred.

This preferred embodiment of the invention is a 17^{th} embodiment of the layered body, that preferably depends on any of the 14^{th} to 16^{th} embodiments of the layered body. In an aspect of the 17^{th} embodiment of the layered body, all possible combinations of the features a. and b. are preferred aspects of the embodiment. These combinations are e.g., a; b; a+b. In a particularly preferred aspect of the 17^{th} embodiment of the layered body, the further oxide comprises alumina and zirconia. In this aspect it is preferred that the further oxide comprise at least two separate crystalline phases of zirconia and alumina, referred to herein as a composite oxide or particulate composite or a zirconia dispersion-toughened alumina (ZTA).

In a preferred embodiment of the layered body, the first layer has at least one or all of the following properties:
a. a value for density divided by theoretical density that is in the range from 0.95 to 1, preferably in the range from 97 to 1, more preferably in the range from 98 to 1, and further preferably in the range from 0.99 to 1; a value of less than 1.0 is further preferred;
b. an average grain size that is in the range from 0.4 to 10 μm, preferably from 0.6 to 8 μm, more preferably from 0.8 to 6.5 μm, even more preferably from 1 to 4 μm, further preferably from 1.1 to 3 μm, further preferably from 1.2 to 3 μm, further preferably from 1.3 to 2.5 μm, and even further preferably from 1.4 to 2.2 μm;
c. a standard deviation for the average grain size distribution that is in the range from 1.2 to 2.8 μm, preferably from 1.6 to 2.4 μm, and more preferably from 1.8 to 2.2 μm;
d. a density in the range from 3.9 to 5 g/cm³, preferably in the range from 4.1 to 4.8 g/cm³, and further preferably in the range from 4.3 to 4.6 g/cm³.

This preferred embodiment of the invention is an 18^{th} embodiment of the layered body, that preferably depends on any of the 1^{st} to 17^{th} embodiments of the layered body. In an aspect of the 18^{th} embodiment of the layered body, all possible combinations of the features a. to d. are preferred aspects of the embodiment. These combinations are e.g., a; b; c; d; a+b; a+c; a+d; b+c; b+d; c+d; a+b+c; a+b+d; a+c+d; b+c+d; a+b+c+d.

In a preferred embodiment of the layered body, the further layer has at least one of all of the following properties:
a. a value for density divided by theoretical density that is in the range from 0.95 to 1, preferably in the range from 97 to 1, more preferably in the range from 98 to 1, and further preferably in the range from 0.99 to 1; a value of less than 1.0 is further preferred;
b. an average grain size of 5 μm or less, preferably 4.5 μm or less, more preferably 4 μm or less, even more preferably 3.5 μm or less, further preferably 3 μm or less, further preferably 2.5 μm or less, further preferably 2 μm or less, further preferably 1.5 μm or less, and even further preferably 1 μm or less;
c. a standard deviation for the average grain size distribution that is in the range from 1.2 to 2.8 μm, preferably from 1.6 to 2.4 μm, and more preferably from 1.8 to 2.2 μm;
d. a density in the range from 3.9 to 4.8 g/cm³, preferably from 4.1 to 4.6 g/cm³, and more preferably from 4.19 to 4.46 g/cm³;
e. a value for density divided by theoretical density of the first layer varies by less than 5%, preferably by less than 3%, and more preferably by less than 1%, from a value for density divided by theoretical density of the further layer.

This preferred embodiment of the invention is a 19^{th} embodiment of the layered body, that preferably depends on any of the 8^{th} to 18^{th} embodiments of the layered body. In an aspect of the 19^{th} embodiment of the layered body, all possible combinations of the features a. to e. are preferred aspects of the embodiment. These combinations are e.g., a; b; c; d; e; a+b; a+c; a+d; a+e; b+c; b+d; b+e; c+d; c+e; d+e; a+b+c; a+b+d; a+b+e; a+c+d; a+c+e; a+d+e; b+c+d; b+c+e; b+d+e; c+d+e; a+b+c+d; a+b+c+e; a+b+d+e; a+c+d+e; b+c+d+e; a+b+c+d+e. In the 19^{th} embodiment of the layered body, the variation of the “value for density divided by theoretical density” preferably applies over the greatest dimension of the layered body. In an aspect of the 19^{th} embodiment of the layered body, feature b., it is preferred that the average grain size is in the range from 1 μm to 3 μm.

In a preferred embodiment of the layered body, the layered body has a diameter of at least 200 mm, preferably at least 300 mm, and more preferably at least 500 mm; the diameter might reach as high as 2000 mm or more; the diameter is preferably not more than 1500 mm, more preferably not more than 900 mm, even more preferably not more than 800 mm, further preferably not more than 700 mm, and even further preferably not more than 650 mm; the diameter is preferably in the range from more than 200 to 625 mm; more preferably from 300 to 625 mm, even more preferably from 400 to 625 mm, and further preferably from 500 to 625 mm.

This preferred embodiment of the invention is a 20^{th} embodiment of the layered body, that preferably depends on any of the 1^{st} to 19^{th} embodiments of the layered body.

In a preferred embodiment of the layered body, the first layer and the further layer touch each other, preferably are contiguous.

This preferred embodiment of the invention is a 21^{st} embodiment of the layered body, that preferably depends on any of the 1^{st} to 20^{th} embodiments of the layered body.

An embodiment of the invention is an assembly comprising a layered body, in turn comprising a first layer, preferably an assembly comprising a layered body according to the invention, more preferably an assembly comprising a layered body according to any of the 1^{st} to 21^{st} embodiments of said layered body. This embodiment is a 1^{st} embodiment of the assembly. In a preferred aspect of the 1^{st} embodiment of the assembly, the assembly is adapted and arranged for the production of components and/or chips in the semiconductor industry.

In a preferred embodiment of the assembly, the assembly is selected from the group consisting of a plasma etcher, a plasma processing chamber (etch or deposition processes), a wear plate for a bearing, a mill liner of a grinding mill, a dielectric window, an RF window, a focus ring, a process ring, a deposition ring, a nozzle or a gas injector, a shower head, a gas distribution plate, an etch chamber liner, a plasma source adapter, a gas inlet adapter, a diffuser, an electrostatic wafer chuck (ESC), a chuck, a puck, an ion suppressor element, a faceplate, an isolator, a spacer, a protective ring in plasma processing chambers, a combination of at least two thereof.

This preferred embodiment of the invention is a 2^{nd} embodiment of the assembly, that preferably depends on the 1^{st} embodiment of the assembly. In a preferred aspect of the 2^{nd} embodiment of the assembly, the assembly is a window, a lid, a chamber top, or a combination thereof, of a plasma etcher. In this aspect, it is further preferred that the layered body comprises a ZTA layer and a YAG layer.

An embodiment of the invention is a device comprising an interior volume, the interior volume being bordered by the following device parts:
i. a first punch interior surface of a first punch;
ii. a second punch interior surface of a second punch; and
iii. an interior surface of a die;
   wherein:
a. the first and second punches are adapted and arranged to apply a pressure of at least 1 MPa, preferably at least 5 MPa, more preferably at least 10 MPa, and further preferably at least 15 MPa, along a compression axis to a target in the interior volume, preferably wherein the target is preferably at least one powder layer, such as the first powder layer;
b. the first punch and the second punch are connected to an electrical power source;
c. the first and second punches comprise at least 50 wt-% carbon, based on the total weight of the punches;
d. the interior volume has a cross-sectional width W of at least 200 mm, preferably at least 300 mm, more preferably at least 400 mm, and further preferably at least 500mm, wherein the cross-sectional width W is perpendicular to the compression axis;
   wherein
the interior volume comprises a first powder, wherein the first powder is a mixture comprising a first constituent powder and a further constituent powder, wherein the first constituent powder and the further constituent powder have different chemical compositions, and wherein the further constituent powder has a particle size distribution D=q(χ) of volume density q over particle size χ, such that
   I./ D has a first local maximum α at particle size χ_{α} with volume density q_{α},
   II./ D has a second local maximum β at particle size χ_{β} with volume density q_{β},
   III./ χ_{α}>χ_{β}, and
   IV./ q_{α}/q_{β} is at least 1, preferably at least 1.4, more preferably at least 1.8, even more preferably at least 2.2, and further preferably at least 2.6.

This embodiment is a 1^{st} embodiment of the device. In the 1^{st} embodiment of the device, the first powder in the interior volume is preferably in the form of a first powder layer.

In a preferred embodiment of the device, the first constituent powder, of the first powder, has a particle size distribution E=r(χ) of volume density r over particle size χ, and wherein E has a global maximum δ at particle size χ_{δ} with volume density r_{δ}, and wherein at least one or all of the following applies
a. χ_{δ} is in the range from 3 to 9 μm, preferably from 4.5 to 7.5 μm, more preferably from 5 to 6.8 μm, and further preferably from 5.5 to 6.3 μm;
b. r_{δ} is in the range from 0.05 to 0.22, preferably from 0.08 to 0.18, and more preferably from 0.11 to 0.15;
c. E is monomodal.

This preferred embodiment of the invention is a 2^{nd} embodiment of the device, that preferably depends on the 1^{st} embodiment of the device. In an aspect of the 2^{nd} embodiment of the device, all possible combinations of the features a. to c. are preferred aspects of the embodiment. These combinations are e.g., a; b; c; a+b; a+c; b+c; a+b+c.

In a preferred embodiment of the invention, at least one of the steps of the process according to any of the 1^{st} to 48^{th} embodiments of the invention are performed using the device according to any of the 1^{st} to 2^{nd} embodiments of the invention.

An embodiment of the invention is a use of a powder, that is a mixture comprising a first constituent powder and a further constituent powder, for producing a layered body that comprises a first layer, wherein
a. the first constituent powder and the further constituent powder have different chemical compositions,
b. the further constituent powder has a particle size distribution D=q(χ) of volume density q over particle size χ, and
c. D has at least two local maxima, preferably at least three local maxima, and further preferably three local maxima.

This embodiment is a 1^{st} embodiment of a use according to the invention. In a preferred aspect of the 1^{st} embodiment of the use, the powder is a first powder. In a preferred aspect of the 1^{st} embodiment of the use, the layered body is produced by sintering, more preferably spark plasma sintering. In a preferred aspect of the 1^{st} embodiment of the use, the layered body has a diameter of at least 200 mm, more preferably at least 300 mm, even more preferably at least 400 mm, and further preferably at least 500 mm. In this aspect, the layered body preferably has a diameter in the range from 200 to 650 mm, more preferably from 300 to 650 mm, even more preferably from 400 to 650 mm, and further preferably from 500 to 650 mm.

In a preferred embodiment of the use
a. D has a first local maximum α at particle size χ_{α} with volume density q_{α},
b. D has a second local maximum β at particle size χ_{β} with volume density q_{β},
c. χ_{α}>χ_{β}, and
d. q_{α}/q_{β} is at least 1, preferably at least 1.4, more preferably at least 1.8, even more preferably at least 2.2, and further preferably at least 2.6.

This preferred embodiment is a 2^{nd} embodiment of a use, that preferably depends on the 1^{st} embodiment of the use.

In a preferred embodiment of the use, the first layer of the layered body has a thickness that is less than or equal to 15 mm, preferably less than or equal to 10 mm, more preferably less than or equal to 8 mm, and further preferably less than or equal to 6 mm.

This preferred embodiment is a 3^{rd} embodiment of a use, that preferably depends on any of the 1^{st} to 2^{nd} embodiments of the use. In a preferred aspect of the 3^{rd} embodiment of the use, the first layer of the layered body has a thickness in the range from 1 to 15 mm, more preferably from 2 to 10 mm, even more preferably from 3 to 8 mm, and further preferably from 4 to 6 mm.

In a preferred embodiment of the use, the powder is further used for at least one or all of the following:
a. increasing a strength of the layered body;
b. decreasing an amount of at least one or all of the following in the first layer of the layered body: the first powder, the first constituent powder, the further constituent powder;
c. decreasing a density variation in the first layer of the layered body.

This preferred embodiment is a 4^{th} embodiment of a use, that preferably depends on any of the 1^{st} to 3^{rd} embodiments of the use. In an aspect of the 4^{th} embodiment of the use, all possible combinations of the features a. to c. are preferred aspects of the embodiment. These combinations are e.g., a; b; c; a+b; a+c; b+c; a+b+c.

The 2^{nd} to 48^{th} preferred embodiments of the process are, mutatis mutandis, also preferred embodiments of the 1^{st} to 3^{rd} embodiments of the device. The 2^{nd} to 48^{th} preferred embodiments of the process are, mutatis mutandis, also preferred embodiments of the 1^{st} to 4^{th} embodiments of the use.

### BRIEF DESCRIPTION OF THE DRAWINGS

The following schematic drawings show aspects of the invention for improving the understanding of the invention in connection with some exemplary illustrations. The figures should thus not be seen as limiting the invention. The figures are not drawn to scale.

FIG. 1A shows a cross-sectional side-view of a device according to the invention.

FIG. 1B shows a cross-sectional side-view of the device of FIG. 1A with the interior volume loaded and ready for sintering.

FIG. 2 is a flow diagram showing the steps of a process, according to the invention, for producing a layered body.

FIGS. 3A and 3B show the core test employed herein.

FIG. 4 shows how to measure an angle of repose of a powder.

FIG. 5 shows how the temperatures of the side and top of the layered body are measured.

FIG. 6 shows the particle size distributions of the first and further constituent powders of the first powder.

FIGS. 7A and 7B show scanning electron microscope images of first layers of layered bodies obtained using different PSDs for the further constituent powder of the first powder.

### DETAILED DESCRIPTION

Features described as preferred in one category of the invention (e.g., the process) are analogously preferred in embodiment of the other categories according to the invention (e.g., the device). Preferred aspects of the invention are preferred aspects of a process for producing a layered body, preferred aspects of a layered body, preferred aspects of an assembly, preferred aspects of a use, and preferred aspects of a device.

Throughout this document, disclosures of ranges should preferably be understood to include both end points of the range. Furthermore, each disclosure of a range in the document should preferably be understood as also disclosing preferred sub-ranges in which one end point is excluded or both end points are excluded. For example, a disclosure of a range from X₁ to X₂ is to be understood as disclosing a range that includes both of the end points X₁ and X₂. Further-more, it is to be understood as also disclosing a range that includes the end point X₁ but excludes the end point X₂, a range that excludes the end point X₁ but includes the end point X₂, and a range that excludes both end points X₁ and X₂.

Some preferred embodiments and preferred aspects have various combinations of features as alternatives. Where these various combinations are disclosed, the combinations are separated by a semi-colon (“;”). For example, the list of the combination of features “a; a+b; a+c+d” for a preferred embodiment discloses a preferred embodiment that comprises the feature “a”, a preferred embodiment that comprises the features “a” and “b”, and a preferred embodiment that comprises the features “a”, “c”, and “d”.

The following abbreviations are used in the description: AC (alternating current), DC (direct current), SPS (spark plasma sintering), RPM (revolutions per minute), YAG (yttrium aluminum garnet), ZTA (zirconia toughened alumina).

“Spark plasma sintering” is also known as “field assisted sintering technology” (FAST) and “direct current sintering” (DCS).

The term “powder” should be understood to collectively refer to the first powder and the further powder (i.e., the first powder and the further powder are examples of a powder). Embodiments, preferred embodiments, and preferred aspects of a powder are thus embodiments, preferred embodiments, and preferred aspects, respectively, of the first powder. Embodiments, preferred embodiments, and preferred aspects of a powder are thus embodiments, preferred embodiments, and preferred aspects, respectively, of the further powder.

The term “purity” refers to the absence of various impurities in a) a starting material (e.g., a constituent powder) from which a powder may be formed, b) a powder, and c) a layered body as disclosed herein. Higher purity, closer to 100%, represents a material having essentially no impurities, comprising only the intended material composition. A preferred intended material composition comprises Y, Al and O.

The term “impurity” refers to those compounds/contaminants present in a) a starting material (e.g., a constituent powder) from which a powder may be formed, b) a powder, and c) a layered body as disclosed herein, other than the intended compounds themselves (e.g., constituent powders of magnesia, alumina, yttria and zirconia, powders, and layered bodies formed therefrom). Impurities may be present in the starting material or may arise from processing (of e.g., of constituent powders or powders) or during sintering.

The term “dopant” refers to a substance added to a constituent powder and/or powder. Impurities differ from dopants in that dopants as defined herein are those substances intentionally added to the constituent powders and/or powders to achieve certain electrical, mechanical, optical, or other properties such as grain size modification for example, in the layered body. The term “dopants” as used herein do not include the powders to the extent they may remain in the layered body.

The term “stabilizing compound” refers to a substance intentionally added to a constituent powder and/or powder. A stabilizing compound as defined herein should not be understood as being an impurity.

The term “alumina” should be understood to mean aluminum oxide, having the chemical formula Al₂O₃. The term “yttria” should be understood to mean yttrium oxide, having the chemical formula Y₂O₃. The term “zirconia” should be understood to mean zirconium dioxide, having the chemical formula ZrO₂.

The term “calcination” should be understood to mean a heat treatment conducted on a constituent powder and/or a powder in air to, for example, remove moisture and/or impurities, increase crystallinity and in some instances modify a specific surface area of a powder.

The term “yttrium aluminum oxide” should be understood to mean at least one of the forms of crystalline phases of yttrium aluminum oxides, including Y₃Al₅O₁₂ (YAG; yttrium aluminum garnet/cubic phase), YAlO₃ (YAP; yttrium aluminum perovskite phase), and Y₄Al₂O₉ (YAM; yttrium aluminum monoclinic phase) and combinations of these. A preferred YAG is polycrystalline. Zirconia toughened alumina (ZTA) should be understood as comprising at least two separate crystalline phases of zirconia and alumina.

The term “phase” should be understood to mean a distinct, crystalline region, portion or layer of a layered body having a specific crystallographic structure.

The term “layer” should be understood to mean a thickness of material, preferably one of several. The material can be, for example, a powder or a region in layered body.

An example of a “target in the interior volume” is one or more powder layers in the interior volume. Examples of a powder layer is a first powder layer and a further powder layer.

The term “layered body” should preferably be understood as an integral article formed by the application of heat and pressure to one or more powder layers, thereby creating a unitary body. Preferably, the layered body is formed by the co-compacting of at least two powder layers, thereby creating the unitary body. The term “co-compacting” refers to the process by which at least two loose powders are introduced into an interior volume to form at least two powder layers, with said at least two powder layers subsequently subjected to the heat and pressure. A layered body according to the invention is preferably free of binders, dispersants, and other similar organic matter as is required for the formation of green or shaped bodies, or tapes as is common in the art. The layered body may be machined into a component useful as a chamber component in plasma processing applications.

The term “unitary” should be understood to mean a single piece or a single unitary part that is complete by itself without additional pieces, i.e., the part is of one monolithic piece formed as a unit. A unitary part may have more than one layer.

The term “layered component” refers to a layered body after a machining step which preferably creates a form or shape of a specific component for use in a semiconductor processing chamber.

The term “annealing” should be understood to mean a heat treatment of a layered body in air, to for example, relieve stress and/or normalize stoichiometry.

The term “ambient temperature” refers to a temperature in the range from 22° C. to 25° C. The term “ambient pressure” should preferably be understood as the air pressure of the atmosphere.

The term “substantially”, as used herein, is a descriptive term that denotes approximation and means “considerable in extent” or “largely but not wholly that which is specified” and is intended to avoid a strict numerical boundary to the specified parameter.

The terms “approximately” and “about” are used in connection with numbers allow for a variance of plus or minus 10%.

### Device

A device according to the invention is adapted and arranged for producing a layered body from at least one powder layer, preferably by sintering of the at least one powder layer, more preferably by spark plasma sintering. A device according to the invention comprises a die, and preferably a first punch and a second punch.

A device according to the invention is preferably connected to an electrical power source, wherein the electrical power source is preferably a DC power source, more preferably a rectified DC power source.

A device according to the invention preferably comprises at least one or all of the following device parts: a housing, a vacuum apparatus, a hydraulic piston, a foil lining at the interior surface of the die, a cooling system adapted and arranged to cool the device, preferably during the step of subjecting at least one powder layer to a heat and pressure. A device according to the invention preferably comprises a sintering chamber adapted and arranged for accommodating an interior volume (i.e., the sintering chamber is adapted and arranged to accommodate the die, the first punch, and the second punch).

A device according to the invention is preferably adapted and arrange to apply an electrical power flux that is in the range from 0.05 to 1.6 W/mm², more preferably from 0.1 to 1.3 W/mm², and further preferably from 0.3 to 1 W/mm², to at least one or all of the following: the die, the interior volume, a target in the interior volume and at least one punch. The electrical power flux is defined as the electrical power input P_{w} calculated using the formula P_{w}=I_{w}*V_{w}/A_{w}, where I_{w} is the current supplied by the electrical power source, V_{w} is the electrical voltage applied across the die, the interior volume, or both, and A_{w} is the surface area over which the electrical voltage is applied.

A device according to the invention is adapted and arranged to apply a pressure to a target in the interior volume, wherein said pressure is preferably applied along a compression axis. Preferably, an angle between the compression axis and the cross-sectional width W of an interior volume is in the range from 88° to 92°, more preferably from 89° to 91°, and further preferably from 89.5° to 90.5°.

### Interior Volume

A device according to the invention comprises an interior volume, wherein said interior volume is at least partially bordered by an interior surface of a die (i.e., a device according to the invention comprises a die). A preferred interior volume is bordered by a first punch interior surface of a first punch, a second punch interior surface of a second punch, and the interior surface of a die (i.e., the device comprises a die and preferably a first punch and a second punch). The interior volume may be bordered by the first punch interior surface, the second punch interior surface and the interior surface of the die only, or may additionally be bordered by one or more further surfaces. It is, however, more preferred that the interior volume is only bordered by the first punch interior surface, the second punch interior surface and the interior surface of the die.

In a preferred aspect of the invention, the die is adapted and arranged to be removable from the device (i.e., the interior volume is removable from the device). In this aspect, it is preferred that the first punch and/or the second punch is/are also adapted and arranged to be removable from the device.

An interior volume according to the invention is adapted and arranged for accommodating at least one powder and/or at least one powder layer. A preferred interior volume is cylindrical. In a preferred aspect of the invention, the cross-sectional width W of the interior volume is at least 300 mm, and more preferably at least 500 mm. The cross-sectional width W might reach as high as 2000 mm or more. In a preferred aspect of the invention, the cross-sectional width W of the interior volume is not more than 1500 mm, more preferably not more than 900 mm, even more preferably not more than 800 mm, further preferably not more than 700 mm, and even further preferably not more than 650 mm. In a preferred aspect of the invention, the cross-sectional width W of the interior volume is preferably in the range from 200 to 650 mm, more preferably from 300 to 650 mm, even more preferably from 400 to 650 mm, and further preferably from 500 to 650 mm. In a preferred aspect of the invention, the cross-sectional width is in the range from 550 to 625 mm.

### Die

A device according to the invention comprises a die having an interior surface. A preferred die is electrically conductive. If the die is electrically conductive, it is preferred for the die to have an isotropic electrical conductivity.

A preferred die comprises one or more elements selected from group 14 of the periodic table. Group 14 elements are sometimes also referred to as group IVA elements or group 4A elements. The die preferably comprises one or more elements selected from the group consisting of: C, Si, Ge, Sn and Pb, more preferably selected from C, Si, Ge and Sn, and further preferably selected from C and Si. C is the most preferred group 14 element. A preferred die comprises at least 50 wt-%, more preferably at least 60 wt-%, even more preferably at least 70 wt-%, further preferably at least 80 wt-%, further preferably at least 90 wt-%, and further preferably at least 95 wt-%, based on the total weight of the die, of group 14 elements.

A preferred die comprises at least 50 wt-%, more preferably at least 60 wt-%, even more preferably at least 70 wt-%, further preferably at least 80 wt-%, further preferably at least 90 wt-%, further preferably at least 95 wt-%, and even further preferably at least 99 wt-% carbon, with the wt-% based on the total weight of the die. A preferred die comprises carbon in the form of graphite. The die is preferably of a carbon material, most preferably of graphite.

A preferred die has at least one wall, wherein said wall comprises at least 50 wt-%, preferably at least 60 wt-%, even more preferably at least 70 wt-%, further preferably at least 80 wt-%, further preferably at least 90 wt-%, further preferably at least 95 wt-%, and even further preferably at least 99 wt-% carbon, based on a total weight of the die.

If a die comprises carbon, said die may additionally comprise one or more further group 14 elements, more preferably selected from Si, Ge, Sn and Pb, even more preferably selected from Si, Ge and Sn, further preferably selected from Si and Ge, and even further preferably Si. Apart from carbon, further group 14 elements are preferably present in the die with a total content of at least 0.1 wt-%, more preferably at least 1 wt-%, and further preferably at least 2 wt-%, based on a total weight of the die. Elements other than C, Si, Ge, Sn and Pb may be present in the die. If elements other than C, Si, Ge, Sn and Pb are present in the die, then it is preferred that these other elements are present with a total content of not more than 1 wt-%, more preferably not more than 0.5 wt-%, and further preferably not more than 0.1 wt-%, based on a total weight of the die.

The die may be a single piece or multiple pieces, preferably a single piece. It is preferred that the die is a single contiguous body, more preferably a single cylindrical body. If the die is of multiple pieces, the die is preferably of 2 to 10 pieces, more preferably of 2 to 5 pieces, more preferably of 2 to 3 pieces, and further preferably of 2 pieces.

### Punches

A device according to the invention preferably comprises a first punch and a second punch. The first punch preferably has a first punch interior surface. A first punch interior surface is preferably substantially perpendicular to an interior surface of a die. A first punch interior surface is preferably a lower surface of the first punch. A first punch interior surface is preferably substantially horizontal. A first punch interior surface is preferably substantially flat. The second punch preferably has a second punch interior surface. A second punch interior surface is preferably substantially perpendicular to an interior surface of a die. A second punch interior surface is preferably an upper surface of the second punch. A second punch interior surface is preferably substantially horizontal. A second punch interior surface is preferably substantially flat. A first punch is preferably arranged above a second punch. The first and second punches are preferably positioned vertically above and below the interior volume, respectively.

The first and second punches are preferably adapted and arranged for applying a pressure to a target within the interior volume, more preferably for producing an elevated pressure in the interior volume. The first and second punches are preferably adapted and arranged for applying the pressure along a compression axis. Preferably, the compression axis is substantially perpendicular to the first punch interior surface and/or the second punch interior surface. The first punch and/or the second punch are/is preferably adapted and arranged to be movable along the compression axis.

The first punch and second punch are preferably adapted and arranged to apply a pressure of at least 1 MPa to a target in the interior volume, more preferably at least 5 MPa, even more preferably at least 10 MPa, and further preferably at least 15 MPa. The first and second punches may be adapted and arrange to apply a pressure of up to 80 MPa, or even more. The first punch and second punch are preferably adapted and arranged to apply a pressure to a target in the interior volume, where the pressure is in the range from 1 to 100 MPa, more preferably from 5 to 60 MPa, even more preferably from 5 to 45 MPa, further preferably from 5 to 30 MPa, and even further preferably from 5 to 15 MPa; preferably in the range from 10 to 60 MPa, more preferably from 10 to 45 MPa, even more preferably from 10 to 30 MPa, and further preferably from 10 to 15 MPa; preferably in the range from 15 to 60 MPa, more preferably from 15 to 45 MPa, even more preferably from 15 to 30 MPa, and further preferably from 15 MPa to 20 MPa.

The first punch and second punch are preferably conductive. The first punch and second punch are preferably adapted and arranged to allow for a current of at least 5 kA across the interior volume, more preferably at least 10 kA, even more preferably at least 50 kA, and further preferably at least 60 kA. The first punch and second punch may be adapted and arranged to allow for a current of up to 100 kA, or even more.

The first punch and second punch are preferably of a carbon material, most preferably of graphite. The first punch and second punch preferably comprise at least 50 wt-%, more preferably at least 60 wt-%, even more preferably at least 70 wt-%, further preferably at least 80 wt-%, further preferably at least 90 wt-%, further preferably at least 95 wt-%, further preferably at least 99 wt-%, and even further preferably at least 99.5 wt-% carbon, based on a total weight of said punches.

The first punch and the further punch preferably have a cross-sectional width that is equal to or smaller than the cross-sectional width W of the interior volume. More preferably, the first punch and the further punch preferably have a cross-sectional width that is in the range from 10 to 200 μm, even more preferably from 30 to 150 μm, and further preferably in the range from 50 to 100 μm smaller than the cross-sectional width W of the interior volume.

### Electrical Power Source

An electrical power source is preferably adapted and arrange for producing Joule heating in a powder layer present in the interior volume. The electrical power source may be adapted and arranged to produce alternating current, pulsed direct current or continuous direct current. Continuous direct current is preferred.

In a preferred aspect of the invention, the electrical power source is a rectified DC power source. A rectified DC power source should preferably be understood to mean an electrical power source that is adapted and arranged to convert an alternating current to a direct current. Examples of a rectified DC power source is an electrical power source that is adapted and arranged to perform partial-wave rectification, full-wave rectification (e.g., a bridge rectifier), or both. A preferred rectified DC power source comprises a silicon-controlled rectifier (SCR), an insulated-gate bipolar transistor (IGBT) based inverter, or both. Here an IGBT transistor is more preferred than an SCR rectifier.

In a preferred aspect of the invention, the electrical power source is adapted an arranged for one or more of the following: to rectify 3-phase alternating current to direct current; to rectify single phase alternating current to direct current.

The electrical power source is preferably adapted and arranged to provide a current of at least 5 kA, more preferably at least 10 kA, even more preferably at least 50 kA, further preferably at least 60 kA, and even further preferably at least 100 kA. The electrical power source is preferably adapted and arranged to provide an electrical current that is in the range from 1 kA to 100 kA, preferably from 5 to 90 kA, more preferably from 10 to 80 kA, even more preferably from 15 to 70 kA, and further preferably from 20 to 60 kA; the electrical power source may be adapted and arranged to provide a current of more than 100 kA.

### Kinds of Contact

If two components of the device are in electrical contact, this should preferably be understood to mean that an electric current can flow between the two components. If two elements are in physical contact, this should preferably be understood to mean that the two elements touch each other. Examples of the two elements include two components of the device, two powder layers (e.g., the first powder layer and a further powder layer) in the interior volume of the device, and two layers (e.g., the first layer and a further layer) of the layered body.

### Powders

If a powder consists of, or comprises, a number of (e.g., one, two) constituent powders, this should preferably not be understood to mean that the constituent powder(s) does/do not comprise, e.g., impurities, stabilizing compounds, sintering aids and dopants.

If a powder is a mixture of at least two constituent powders, said constituent powders are preferably mixed prior to subjecting the powder to a heat and a pressure in the interior volume. If a powder is a mixture of at least constituent powders, it should preferably be understood that there is at least one property that differs between the at least two constituent powders. Examples of the at least one property include an average particle size, a specific surface area, a chemical composition. In a particularly preferred aspect of the invention, the at least two constituent powders have a different chemical composition.

In the present invention the wording “first constituent powder” and “further constituent powder” is used to distinguish two constituent powders from each other in the context of a mixture making up a specific powder. For example, a first constituent powder of a first powder and a first constituent powder of a further powder may, or may not, have the same chemical composition. For example, a first constituent powder of a first powder and a further constituent powder of a further powder may, or may not, have the same chemical composition. For example, a further constituent powder of a first powder and a further constituent powder of a further powder may, or may not, have the same chemical composition. For example, a further constituent powder of a first powder and a first constituent powder of a further powder may, or may not, have the same chemical composition. The above should preferably also be understood to apply to an even-further powder and any powder that is a mixture of at least two constituent powders.

A further powder may consist of a single constituent powder. It is, however, more preferred that a further powder is a mixture of at least two constituent powders.

In a preferred aspect of the invention, the first powder is polycrystalline or crystalline. In a preferred aspect of the invention, the further powder is polycrystalline or crystalline. A crystalline powder should preferably be understood as having a single crystal structure.

An even-further powder may consist of a single constituent powder. It is, however, more preferred that an even-further powder is a mixture of at least three constituent powders. In a preferred aspect of the invention, the even-further powder is a mixture of yttria powder, alumina powder and at least one of partially stabilized and stabilized zirconia (with partially stabilized zirconia being more preferred). In this aspect, it is preferred that the even-further powder comprises yttria in an amount by weight of from 1 to 57%, more preferably from 3 to 57%, and further preferably from 5 to 57%, relative to the weight of the even-further powder. In this aspect, it is preferred that the even-further powder comprises yttria in an amount by weight of from 1 to 40%, more preferably from 1 to 30%, even more preferably from 3 to 30%, further preferably from 5 to 30%, and even further preferably from 5 to 15%, relative to the weight of the even-further powder. In this aspect, it is preferred that the even-further powder comprises alumina in amounts by weight of from 43% to 92.5%, and more preferably from 65% to 75%, relative to the weight of the even-further powder. In this aspect, it is preferred that the even-further powder comprises zirconia in amounts by weight of from 0.4% to 40%, more preferably from 4% to 40%, even more preferably from 15% to 40%, and further preferably from 15% to 25%, relative to the weight of the even-further powder. For example, the even-further powder comprises by weight 6% yttria, 73% alumina, and 21% zirconia, relative to the weight of the even-further powder.

A preferred zirconia powder may comprise stabilizing compounds comprising at least one selected from the group consisting of yttria, lanthanum oxide (La₂O₃), ceria, magnesia, samaria (Sm₂O₃), calcia, and combinations of at least two thereof. To form partially stabilized zirconia, these stabilizing compounds may each be present in amounts of from 0.5 to 50 mol-%, preferably from 0.5 to 30 mol-%, preferably from 0.5 to 15 mol-%, preferably from 0.5 to 10 mol-%, preferably from 1 to 50 mol-%, preferably from 1 to 30 mol-%, preferably from 1 to 10 mol-%, preferably from 1 to 5 mol-%, and preferably about 3 mol-%. To form stabilized zirconia, these stabilizing compounds may each be present in amounts of from greater than 6 to 45 mol-%, preferably from greater than 10 to 45 mol-%, preferably from greater than 25 to 45 mol-%, preferably from greater than 6 to 30 mol-%, preferably from greater than 6 to about 15 mol-%, preferably from greater than 8 to 15 mol-%.

Preferably, zirconia is partially or fully stabilized using yttria. Preferably, zirconia is partially yttria stabilized zirconia or fully yttria stabilized zirconia. Partially yttria stabilized zirconia may be formed from powder mixtures comprising from 1 to 10 mol-% yttria, preferably from 1 to 8 mol-% yttria, preferably from 1 to 5 mol-% yttria, preferably from 2 to 4 mol-% yttria, preferably about 3 mol-% yttria.

In a preferred aspect of the invention, the first powder and/or the further powder have a specific surface area (SSA) that is in the range from 1 to 18 m²/g, preferably from 1 to 14 m²/g, preferably from 1 to 10 m²/g, preferably from 1 to 8 m²/g, preferably from 2 to 18 m²/g, preferably from 2 to 14 m²/g, preferably from 2 to 10 m²/g, preferably from 3 to 9 m²/g, preferably from 3 to 6 m²/g.

A powder may comprise at least one metal oxide. A constituent powder may be a metal oxide. Here the metal element that forms the oxide may be one or two or more selected from metalloid elements such as boron (B), silicon (Si), germanium (Ge), antimony (Sb) and bismuth (Bi); representative elements such as magnesium (Mg), calcium (Ca), strontium (Sr), barium (Ba), zinc (Zn), aluminum (Al), indium (In), tin (Sn); transition metal elements such as scandium (Sc), yttrium (Y), titanium (Ti), zirconium (Zr), hafnium (Hf), vanadium M, niobium (Nb), tantalum (Ta), chromium (Cr), molybdenum (Mo), tungsten (W), manganese (Mn), iron (Fe), cobalt (Co), nickel (Ni), copper (Cu), silver (Ag) and gold (Au); and lanthanoid elements such as lanthanum (La), cerium (Ce), praseodymium (Pr), neodymium (Nd), samarium (Sm), europium (Er) and lutetium (Lu).It is preferable that the metal element is one or more elements selected from Mg, Y, Ti, Zr, Cr, Mn, Fe, Zn, Al, and Er, and more preferably selected from Y, Al, and Zr.

In a preferred aspect of the invention, a powder has a d₁₀ particle size that is in the range from 0.1 to 4 μm, preferably from 0.2 to 4 μm, more preferably from 0.3 to 4 μm, and further preferably from 0.4 to 4 μm. In another preferred aspect of the invention, a powder has a d₁₀ particle size that is in the range from 0.1 to 3 μm, more preferably from 0.1 to 2 μm, even more preferably from 0.1 to 3 μm, further preferably from 0.1 to 2 μm, and even further preferably from 0.1 to 1 μm. In a preferred aspect of the invention, at least one or all of the above-mentioned d₁₀ particle sizes apply after the powder has been subjected to a heat treatment, such as calcination.

In a preferred aspect of the invention, a powder has a d₅₀ particle size that is in the range from 3 to 50 μm, preferably from 3 to 40 μm, more preferably from 3 to 30 μm, even more preferably from 3 to 20 μm, further preferably from 3 to 10 μm, and even further preferably from 3 to 8 μm. In another preferred aspect of the invention, a powder has a d₅₀ particle size that is in the range from 5 to 50 μm, more preferably from 10 to 50 μm, even more preferably from 20 to 50 μm, and further preferably from 30 to 50 μm. In yet another preferred aspect of the invention, a powder has a d₅₀ particle size that is in the range from 5 to 10 μm. In a further preferred aspect of the invention, a powder has a d₅₀ particle size that is in the range from 6 to 15 μm. In a preferred aspect of the invention, at least one or all of the above-mentioned d₅₀ particle sizes apply after the powder has been subjected to a heat treatment, such as calcination.

In a preferred aspect of the invention, a powder has a d₉₀ particle size that is in the range from 10 to 350 μm, preferably from 10 to 300 μm, more preferably from 10 to 250 μm, even more preferably from 10 to 200 μm, further preferably from 10 to 175 μm, further preferably from 10 to 150 μm, further preferably from 10 to 100 μm, further preferably from 10 to 75 μm, further preferably from 10 to 50 μm, further preferably from 10 to 40 μm, and even further preferably from 10 to 25 μm. In another preferred aspect of the invention, a powder has a d₉₀ particle size that is in the range from 20 to 350 μm, more preferably from 40 to 350 μm, even more preferably from 60 to 350 μm, further preferably from 100 to 350 μm, further preferably from 150 to 350 μm, and even further preferably from 200 to 350 μm. In yet another preferred aspect of the invention, a powder has a d₉₀ particle size that is in the range from 12 to 330 μm, more preferably from 100 to 330 μm, and further preferably from 100 to 250 μm. In a preferred aspect of the invention, at least one or all of the above-mentioned doo particle sizes apply after the powder has been subjected to a heat treatment, such as calcination.

In a preferred aspect of the invention, the first powder has a purity of at least 95%, preferably at least 97%, more preferably at least 99%, even more preferably at least 99.99%, further preferably at least 99.999%, and even further preferably at least 99.9999%.

Any powder that the skilled person deems suitable for the present invention may be used. Suitable powders are well-known and commercially available from a number of suppliers.

### Constituent Powders of First Powder

In an aspect of the invention, a first powder is a mixture comprising at least two constituent powders. In a preferred aspect of the invention, the first powder is a mixture of yttria powder and alumina powder. In this aspect, it is preferred that the first powder is a stoichiometric powder mixture of 37.4 to 37.6 mol-% yttria and 62.6 and 62.4% mol alumina, and more preferably 37.5 mol-% yttria and 62.5 mol-% alumina. By weight, a first powder may be formed from a mixture of 42.9 to 43.4% alumina and 56.6 to 57.1% yttria. In this aspect, a first constituent powder of the first powder is preferably a yttria powder. In this aspect, a further constituent powder of the first powder is preferably an alumina powder.

In a preferred aspect of the invention, a first constituent powder (e.g., yttria) of a first powder has a specific surface area that is in the range from 0.1 to 8 m²/g, more preferably from 0.5 to 7 m²/g, even more preferably from 1 to 6 m²/g, and further preferably from 1.5 to 4 m²/g.

In another preferred aspect of the invention, a first powder and/or a constituent powder is a YAG powder. In this aspect, it is preferred that the YAG powder has a d₅₀ particle size that is in the range from 3 to 10 μm, more preferably from 4 to 9 μm, and even more preferably from 5 to 8 μm.

In a preferred aspect of the invention, the first constituent powder, of the first powder, has a purity of at least 95%, preferably at least 97%, more preferably at least 99%, even more preferably at least 99.99%, further preferably at least 99.999%, and even further preferably at least 99.9999%. In another preferred aspect of the invention, the further constituent powder, of the first powder, has a purity of at least 95%, preferably at least 97%, more preferably at least 99%, even more preferably at least 99.99%, further preferably at least 99.999%, and even further preferably at least 99.9999%.

Any constituent powders, of the first powder, that the skilled person deems suitable for the present invention may be used. Suitable constituent powders are well-known and commercially available from a number of suppliers.

### Constituent Powders of Further Powder

In a preferred aspect of the invention, a further powder is a mixture comprising at least two constituent powders. In a preferred aspect of the invention, the further powder is a mixture of alumina powder and at least one of partially stabilized and stabilized zirconia, with partially stabilized zirconia being more preferred. In this aspect, it is preferred that the further powder comprises alumina in an amount by weight of from 60% to 92.5%, and more preferably from 75% to 85%, relative to the weight of the further powder. In this aspect, it is preferred that the further powder comprises zirconia in an amount by weight of from 7.5% to 40%, and more preferably from 15% to 25%, relative to the weight of the further powder. For example, the further powder is a mixture of 77% alumina and 23% zirconia. In this aspect, a first constituent powder of the further powder is preferably a zirconia powder, more preferably a zirconia powder that comprises at least one or all of the following: partially stabilized zirconia, and stabilized zirconia, with partially stabilized zirconia being more preferred. In this aspect, a further constituent powder of the further powder is preferably an alumina powder.

In a preferred aspect of the invention, a first constituent powder (e.g., zirconia) of a further powder has a specific surface area that is in the range from 1 to 16 m²/g, more preferably from 2 to 14 m²/g, even more preferably from 4 to 12 m²/g, and further preferably from 6 to 10 m²/g.

In a preferred aspect of the invention, a further constituent powder (e.g., alumina) of a further powder has a specific surface area that is in the range from 1 to 16 m²/g, more preferably from 2 to 14 m²/g, even more preferably from 4 to 12 m²/g, and further preferably from 6 to 10 m²/g.

Any constituent powders that the skilled person deems suitable for the present invention may be used for the further powder. Suitable constituent powders are well-known and commercially available from a number of suppliers.

### Particle Size Distribution of Constituent Powder

According to an aspect of the invention, the further constituent powder, of the first powder, has a particle size distribution D=q(χ) of volume density q over particle size χ. Here the volume density q should be understood as the fractional volume (expressed as a percentage) that particles with a particle size χ make up of the total cumulative volume of the further constituent powder. Integrating q over all particle sizes χ therefore leads to the total cumulative volume (i.e., 100%) of the further constituent powder. The definition of q, as provided above, also apply to the particle size distributions of powders and any other constituent powders.

A local maximum of a particle size distribution (PSD) should preferably be understood as also including a global maximum. I.e., a local maximum may be a global maximum. A local maximum of a PSD should preferably not be understood as noise in said PSD.

A local maximum of a PSD should preferably also be understood as being a mode of the particle size distribution. A monomodal PSD should preferably be understood as having a single mode. A multimodal PSD should preferably be understood as having more than one mode. Examples of a multimodal PSD include a bimodal PSD and a trimodal PSD. A bimodal PSD should preferably be understood as having two modes. A trimodal PSD should preferably be understood as having three modes. The modes of a multimodal PSD are also not required to have the same q value.

### Heat Treatment of Powders

In an aspect of the invention, it is preferred to subject at least one powder and/or at least one constituent powder, used in the process for producing a layered body, to a heat treatment (here the at least one powder is, e.g., the first powder and the further powder; here the at least one constituent powder is, e.g., a first constituent powder of a first powder, a further constituent powder of a first powder, a first constituent powder of a further powder). In this aspect, it is preferred to subject the at least one powder to the heat treatment prior to subjecting the at least one powder to a heat and a pressure in the interior volume of the device. In this aspect, it is preferred to subject the at least one powder to the heat treatment prior to introducing the at least one powder into the interior volume of the device.

A preferred heat treatment of a powder is the calcining of the powder. A preferred heat treatment of a constituent powder is the calcining of the constituent powder.

A heat treatment of a powder and/or constituent powder is preferably performed under ambient pressure in an oxygen containing environment, although other pressures and calcination environments may be used. A preferred oxygen containing environment is the ambient atmosphere.

A heat treatment of a powder and/or constituent powder is preferably performed at a temperature that is in the range from 600 to 1100° C., more preferably from 600 to 1000° C., even more preferably from 600 to 900° C. A heat treatment of a powder and/or constituent powder is preferably performed at a temperature that is in the range from 700 to 1100° C., more preferably from 800 to 1100° C., even more preferably from 800 to 1000° C., and further preferably from 850 to 950° C.

A heat treatment of a powder and/or constituent powder preferably has a duration that is in the range from 4 to 12 hours, more preferably from 4 to 10 hours, even more preferably from 4 to 8 hours, and further preferably from 4 to 6 hours. Alternatively, a heat treatment of a powder and/or constituent powder preferably has a duration that is in the range from 6 to 12 hours.

A heat treatment of a powder and/or constituent powder is preferably performed in a vessel comprising a first cavity, e.g., a crucible and a kiln. Any vessel which the skilled person deem suitable may be used for the heat treatment of a powder and/or constituent powder. Such vessels are well known to the skilled person. An example of a suitable vessel is a model VIK283 kiln commercially available from Paragon Industries, L.P. (Mesquite, Texas, USA).

### Mixing and Milling

If a powder (e.g., the first powder, the further powder) is a mixture of at least two constituent powders (e.g., a first constituent powder and a further constituent powder), then the mixing of the at least two constituent powders may be performed using at least one or all of the following: wet ball milling, dry ball milling, wet tumble mixing, dry tumble mixing, jet milling, or a combination of at least two thereof. A preferred ball milling uses axial rotation to mix the at least two constituent powders. A preferred tumble mixing uses end-over-end, or vertical rotation, to mix the at least two constituent powders. The at least two constituent powders are mixed in a volume section, such as a vessel or a drum.

Ball milling (dry ball milling, wet ball milling) and/or tumble mixing (dry tumble mixing, wet tumble mixing) preferably uses high purity (>99.99%) alumina media (media is also referred to as agitation means herein). In other instances where agglomeration may be of concern, it is preferred to use a harder media such as zirconium oxide. Media loading for ball milling and/or tumble mixing may vary between large dimension (about 30 mm) media elements to a media loading of about 50% by powder weight.

Dry ball milling and/or dry tumble mixing is preferably performed for a duration that is in the range from 12 to 48 hours, more preferably from 16 to 48 hours, and even more preferably from 24 to 48 hours. Dry ball milling and/or dry tumble mixing is preferably performed in a volume section that is rotated at a rate that is in the range from 50 to 200 RPM, more preferably from 75 to 150 RPM, and even more preferably from 100 to 125 RPM.

Wet ball milling and/or wet tumble mixing is preferably performed by suspending the at least two constituent powders in at least one solvent and/or water to form a slurry. A preferred solvent is an alcohol, such as ethanol and methanol. Ethanol is particularly preferred. The slurry may be formed having a powder loading during milling and/or mixing of preferably from 5 to 50% by powder weight, more preferably from 10 to 40% by powder weight, and even more preferably from 20 to 40% by powder weight. When employing wet ball milling and/or wet tumble mixing, a dispersant may optionally be added to the slurry using any number of commercially available dispersants such as, e.g., poly methyl methacrylate (PMMA) and polyvinyl pyrrolidone (PVP). The dispersant may optionally be added in amounts from zero (no dispersant) to 0.2% by powder weight, optionally from 0 to 0.1% by powder weight. Media loadings may be varied from having no media used during wet ball milling, to media at a loading of 50% and greater by powder weight, more preferably from 40 to 90% by powder weight, even more preferably from 50 to 80% by powder weight. Wet ball milling and/or wet tumble mixing is preferably performed for a duration of from 8 to 48 hours, more preferably from 12 to 48 hours, and even more preferably from 16 to 48 hours. Wet ball milling and/or wet tumble mixing is preferably performed for a duration of from 8 to 36 hours, more preferably from 8 to 24 hours, and even more preferably from 8 to 12 hours. Wet ball milling is preferably performed in a volume section that is rotated at a rate that is in the range from 50 to 200 RPM, more preferably from 75 to 150 RPM, and even more preferably from 100 and 125 RPM. The RPM values are preferably for a volume section that has diameter up to 200 mm. Wet tumble mixing is preferably performed at an RPM of from 10 to 30 RPM, and more preferably from 15 to 25 RPM.

Jet milling processes, as known to those skilled in the art may, also be used to mix the at least two constituent powders to form a powder. Jet milling uses high velocity jets of inert gases and/or air to collide particles of the at least two constituent powders without the use of milling or mixing media. The volume section may be designed such that larger particles may be preferentially reduced in size, which may provide a narrow particle size distribution in the powder. A powder preferably exits the volume section upon reaching a desired particle size as determined at setup of the jet milling machine prior to mixing.

The at least two constituent powders and/or the powder may be subjected to jet milling at pressures of about 100 psi, whether separately, or in combination with any, or all of, the as disclosed powder milling and/or mixing processes as disclosed herein. After jet milling, the powder may optionally be sieved using any number of meshes which may have openings of, e.g., from 45 to 400 μm, and/or blended, without limitation as to repetition or order.

Any device which the skilled person deems suitable for the mixing and/or milling may be used. Such devices are well known. An example is a wet tumble mixer, such as a Model 309-E3, 55-gallon drum tumbler from Morse Manufacturing Company, Inc. (Syracuse, New York, USA).

### Introduction of Powder Into Interior Volume

In a preferred aspect of the invention, when a powder is introduced into the interior volume, said powder is introduced while the interior volume is removed from the device (i.e., the die, the first punch and the second punch are removed from the device). Here “removed” should preferably be understood that the interior volume is located outside the device, e.g., outside a sintering chamber of the device. In a preferred aspect of the invention, following the introduction of a powder into the interior volume, the powder is spread to form a powder layer. In another preferred aspect of the invention, when one or more, more preferably all, powder layers are present in the interior volume, the interior volume is placed in the device, further preferably in a sintering chamber of the device (i.e., the die, the first punch and the second punch are placed in a sintering chamber of the device).

### Powder Layers

In a preferred aspect of the invention, the first powder and the first powder layer preferably have the same chemical composition. In a preferred aspect of the invention, the first powder layer comprises at least 75 wt-%, more preferably at least 85 wt-%, even more preferably at least 95 wt-%, and further preferably at least 99 wt-% of the first powder, with the wt-% based on the total weight of the first powder layer. In a preferred aspect of the invention, the first powder layer consists of the first powder.

In a preferred aspect of the invention, the further powder and the further powder layer preferably have the same chemical composition. In a preferred aspect of the invention, the further powder layer comprises at least 75 wt-%, more preferably at least 85 wt-%, even more preferably at least 95 wt-%, and further preferably at least 99 wt-% of the further powder, with the wt-% based on the total weight of the further powder layer. In a preferred aspect of the invention, the further powder layer consists of the further powder.

### Oxides A and B

The wording “oxide A” and “oxide B” are used to distinguish said oxides from each other, and to denote oxides with the one or more properties indicted below.

An oxide A comprises at least 1 mol-% of an element of the 3^{rd} group (former group IIIB), preferably yttrium, and at least 1 mol-% of an element of the 13^{th} group (former group IIIA), preferably aluminium, wherein the mol-% is based on the oxygen in the oxide A. Preferably, the oxide A is a cubic phase of yttrium aluminium oxide, more preferably YAG. In a preferred aspect of the invention, the oxide A comprises at least 3 mol-%, more preferably at least 5 mol-%, and further preferably at least 7 mol-% of an element of the 3^{rd} group (former group IIIB). In a preferred aspect of the invention, the oxide A comprises at least 3 mol-%, more preferably at least 5 mol-%, and further preferably at least 7 mol-% of an element of the 13^{th} group (former group IIIA). It is particularly preferred that a first oxide, as used herein, is the oxide A.

An oxide B comprises at least 1 mol-% of an element of the 4^{th} group (former group IVB), preferably zirconium, and at least 1 mol-% of an element of the 13^{th} group (former group IIIA), preferably aluminium, wherein the mol-% is based on the oxygen in the oxide B. Preferably, the oxide B is ZTA. In a preferred aspect of the invention, the oxide B comprises at least 3 mol-%, more preferably at least 5 mol-%, and further preferably at least 7 mol-% of an element of the 4^{th} group (former group IVB). In a preferred aspect of the invention, the oxide B comprises at least 3 mol-%, more preferably at least 5 mol-%, and further preferably at least 7 mol-% of an element of the 13^{th} group (former group IIIA). It is particularly preferred that a further oxide, as used herein, is the oxide B.

### Process for Producing Layered Body

An aspect of the invention relates to a process for producing a layered body. In this aspect, a preferred process is a sintering process, more preferably a spark plasma sintering process. A preferred spark plasma sintering process produces a layered body by the application of heat and pressure to at least one powder layer. The heat is preferably obtained through the use of an electrical current.

A preferred process for producing a layered body increases a density of the at least one powder layer to produce the layered body.

A preferred process for producing a layered body may employ a dopant. The term “dopant” as used herein is a substance added to a powder and/or a layered body to produce a desired characteristic in the layered body (e.g., to alter electrical properties). If one or more dopants are employed, it is preferred that a powder and/or layered body comprises the one or more dopants in an amount that is in the range from 0.002 to <0.05 wt-%, more preferably from 0.0035 to 0.02 wt-%, and further preferably from 0.0075 to 0.01 wt-%. Examples of dopants include Sc, La, Er, Ce, Cr, Pr, Nd, Pm, Sm, Eu, Gd, Tb, Dy, Ho, Tm, Yb, Lu, Zr and oxides and combinations thereof.

A preferred process for producing a layered body does not employ a sintering aid. The term “sintering aid” as used herein refers to compounds, such as silica (SiO₂), lithia (Li₂O), lithium fluoride (LiF), magnesia (MgO), and/or calcia (CaO), that are added to a powder to enhance densification, thereby reducing porosity, during the process for producing a layered body. If a sintering aid is employed, it is preferred that a powder comprises 5 ppm or less, and more preferably 2 ppm or less of a sintering aid.

### Application of Heat and Pressure

In an aspect of the invention, the step of subjecting the first powder layer in the interior volume, and/or any other powder layers present in the interior volume, to the heat and pressure leads to a layered body being obtained. It should preferably be understood that the layered body generally starts forming prior to completion of the step of subjecting the first powder layer to the heat and pressure (e.g., a partially formed or formed layered body may be present in the interior volume during the step of subjecting the first powder layer to the heat and pressure). The step of subjecting the first powder layer to the heat and pressure therefore preferably further includes subjecting at least one or all of the following to the heat and pressure: a partially formed layered body (in the interior volume), a formed layered body (in the interior volume). The step of subjecting the first powder layer to the heat and pressure preferably ends by the removal of the electrical voltage applied across the die, the interior volume, or both.

During the step of applying the heat and pressure to the first powder layer in the interior volume, and/or any other powder layer present in the interior volume, the order of application of the heat and pressure, to obtain the desired pressure and temperature for producing the layered body, may vary as disclosed herein. In one aspect of the invention, it is preferred to apply the pressure to obtain the desired pressure for producing the layered body, and therein after to apply the heat to obtain the desired temperature for producing the layered body. In another aspect of the invention, it is preferred to apply the heat to obtain a desired temperature for producing the layered body, and therein after to apply the pressure to obtain the desired pressure for producing the layered body. In yet another aspect of the invention, it is preferred to apply the heat and the pressure at least partially simultaneously, more preferably simultaneously, to obtain the desired temperature and pressure for producing the layered body. In another preferred aspect of the invention, step of applying the heat and pressure may comprise at least two sub-steps, wherein the at least two sub-steps are distinguished form each other by a change in the temperate of the heat and/or the pressure that is applied.

In one aspect of the invention, it is preferred that the first powder layer in the interior volume, and any other powder layer present in the interior volume, is heated by the die, or the punches, or both. In this aspect, it is preferred that the heating is done via the die and punches.

Applying heat and pressure to a powder layer leads to the formation of a layer of a layered body. For example, the application of heat and pressure to a first powder layer and a further powder layer leads to the formation of a first layer and a further layer, respectively, of a layered body.

In a preferred aspect of the invention, the step of applying heat and pressure is performed for a duration of from 4 to 20 hours, preferably from 6 to 16 hours, more preferably from 8 to 14 hours, and further preferably from 10 to 12 hours.

In a preferred aspect of the invention, during the step of applying heat and pressure, a maximum temperature and pressure is applied for a duration of from 0.5 to 180 minutes, more preferably from 0.5 to 120 minutes, even more preferably from 0.5 to 100 minutes, further preferably from 0.5 to 80 minutes, further preferably from 0.5 to 60 minutes, further preferably from 0.5 to 40 minutes, further preferably from 0.5 to 20 minutes, further preferably from 0.5 to 10 minutes, and even further preferably from 0.5 to 5 minutes. In a preferred aspect of the invention, during the step of applying the heat and pressure, a maximum temperature and pressure is applied for a duration of from 5 to 120 minutes, more preferably from 10 to 120 minutes, even more preferably from 20 to 120 minutes, further preferably from 40 to 120 minutes, further preferably from 60 to 120 minutes, and even further preferably from 100 to 120 minutes. In a preferred aspect of the invention, during the step of applying the heat and pressure, a maximum temperature and pressure is applied for a duration of from 30 to 90 minutes.

In a preferred aspect of the invention, during the step of subjecting the first powder layer, and/or any other powder layer present in the interior volume, to the heat and pressure, a maximum temperature in the interior volume is in the range from 900 to 2000° C., preferably from 950 to 1900° C., more preferably from 1000 to 1800° C., and further preferably from 1050 to 1700° C.; preferably 1000 to 1700° C., more preferably from 1100 to 1700° C., even more preferably from 1200 to 1700° C., further preferably from 1300 to 1700° C., and even further preferably from 1400 to 1700° C.

In a preferred aspect S1 of the invention, the step of applying the heat and pressure to the first powder layer in the interior volume, and/or any other powder layer present in the interior volume, comprises a first sub-step S_{RAMP} and a further sub-step S_{SINT}. In this aspect S1, it is preferred that during the first sub-step S_{RAMP}, the temperature in the interior volume is increased at a rate that is in the range from 1 to 100° C./min, more preferably from 2 to 50° C./min, even more preferably from 3 to 25° C./min, further preferably from 3 to 10° C./min, and even further preferably 5 to 10° C./min. In this aspect S1, it is preferred that the maximum temperature during the first sub-step S_{RAMP} is in the range from 900 to 1300° C. In this aspect S1, it is preferred that during the further sub-step S_{SINT}, the temperature in the interior volume is increased at a rate that is in the range from 0.5 to 5° C./min, preferably from 1 to 4° C./min, and further preferably from 1.5 to 3° C./min. In this aspect S1, it is preferred that a maximum temperature in the interior volume during the further sub-step S_{SINT} is in the range from 1100 to 2000° C., preferably from 1300 to 1850° C., more preferably from 1450 to 1750° C., and further preferably from 1575 to 1675° C. In this aspect S1, it is preferred that, during the further sub-step S_{SINT}, the pressure in the interior volume is increased at a rate that is in the range from 0.5 MPa/min to 30 MPa/min, more preferably from 0.75 MPa/min to 10 MPa/min, and even more preferably from 1 to 5 MPa/min.

### Cooling of Layered Body

In a preferred embodiment C1, the process for producing the layered body comprises a step of reducing a temperature of the layered body once said layered body has been obtained. In a preferred aspect of the embodiment C1, the layered body is passively cooled by removing the heat source (e.g., by removing the application of the electrical voltage applied across the die, the interior volume, or both; by removing the power applies to the device used for producing the layered body). In another aspect of the embodiment C1, the layered body is cooled under convection with inert gas, for example, at 1 bar of argon or nitrogen. Other gas pressures of greater than or less than 1 bar may also be used. In a further aspect of the embodiment C1, the layered body is cooled under forced convective conditions in an oxygen environment.

In a preferred aspect of the embodiment C1, the pressure applied to the interior volume is also reduced during the step of reducing the temperature of the layered body (e.g., the pressure applied by the first and second punches is removed). In a preferred aspect of the embodiment C1, the temperature of the layered body may be reduced under vacuum conditions.

The temperature of the layered body may be reduced at a rate that is preferably in the range from 0.5 to 20° C./min, more preferably from 1 to 10° C./min, even preferably from 1 to 8° C./min, further preferably from 1 to 5° C./min; preferably from 2 to 10° C./min, more preferably from 2 to 8° C./min, and further preferably from 2 to 5° C./min.

### Further Aspects of the Process

In a preferred aspect V1 of the invention, the process for producing the layered body further comprises the step of reducing a gas pressure in the interior volume, wherein the reducing step is preferably performed after introducing the first powder into the interior volume, and/or after introducing any other powder layer present into the interior volume.

In the aspect V1, it is preferred that the gas pressure is reduced prior to subjecting the first powder layer, and/or any other powder layer present into the interior volume, to the heat and the pressure. In the aspect V1, it is preferred that the gas pressure is reduced to be 10 mPa or less, more preferably 5 mPa or less, and further preferably 1 mPa or less. Preferably the gas pressure is reduced to be in the range from 1 mPa to 10 mPa.

In a preferred aspect V1 of the invention, the process for producing the layered body is performed in at least one or all of the following: a non-oxidizing atmosphere; an inert atmosphere, more preferably an atmosphere comprising argon.

### Layered Body

A layered body according to the invention comprises at least a first layer. This should not be understood to mean that the layered body must comprise more than one layer, i.e., this should not be understood to mean that the layered body comprises one or more further layers in addition to the first layer. A layered body may consist of only the first layer. It is, however, more preferred that the layered body has at least a first layer and a further layer. If a layered body comprises a first layer and a further layer, it is preferred that the first layer and the further layer touch each other.

A process according to the invention produces a layered body, wherein the layered body is obtained from at least one powder layer that has been subjected to a heat and a pressure in the interior volume of the device. For example, the first layer of the layered body is obtained from a first powder layer by subjecting the first powder layer to a heat and a pressure in the interior volume of the device. It is preferred that the first layer of the layered body is obtained from the first powder layer. If the layered body has a further layer, it is preferred that the further layer is obtained from a further powder layer.

A preferred layered body has a higher density than the at least one powder layer. A preferred layered body has a density at least 95%, more preferably at least 99%, and further preferably at least 99.9% of its theoretical density. A preferred layered body is a contiguous item.

A preferred layered body comprises at least one element selected from the group consisting of oxygen, nitrogen, carbon, yttrium, zirconium, aluminium, titanium, silicon, boron, phosphorus and beryllium. These elements could be constituents of oxides, nitrides, carbides.

If the layered body comprises oxygen, then the layered body is often quantified in terms of the content of simple oxides which would be required to prepare them. Some preferred oxide constituents are, silica, boria, beryllium oxide, yttrium oxide, aluminum oxide, zirconium oxide, titanium oxide, silicon dioxide, quartz, calcium oxide, cerium oxide, nickel oxide, copper oxide, strontium oxide, scandium oxide, samarium oxide, hafnium oxide, vanadium oxide, niobium oxide, tungsten oxide, manganese oxide, tantalum oxide, terbium oxide, europium oxide, neodymium oxide, yttrium aluminate oxide, zirconium aluminate oxide, lanthanum oxide, lutetium oxide and erbium oxide.

If the layered body comprises nitrogen, then the layered body is often quantified in terms the content of simple nitrides which would be required to prepare them. Some preferred nitride constituents are one or more selected from the group consisting of: silicon nitride, titanium nitride, yttrium nitride, aluminum nitride, boron nitride, beryllium nitride and tungsten nitride.

If the layered body comprises carbon, then the layered body is often quantified in terms the content of simple carbides which would be required to prepare them. Some preferred carbide constituents are silicon carbide, tungsten carbide, chromium carbide, vanadium carbide, niobium carbide, molybdenum carbide, tantalum carbide, titanium carbide, zirconium carbide, hafnium carbide and boron carbide.

The layered body may comprise one or more borides. Some preferred boride constituents of the layered body are one or more selected from the group consisting of: molybdenum boride, chromium boride, hafnium boride, zirconium boride, tantalum boride and titanium boride or titanium diboride.

A preferred layered body comprises one or more species selected from the group consisting of: sapphire, alumina, yttrium aluminium monoclinic (YAM), preferably Y₄Al₂O₉, yttrium aluminum garnet (YAG), preferably Y₃Al₅O₁₂, yttrium aluminum perovskite (YAP), preferably YAlO₃, cordierite, mullite, magnesium aluminate spinel, zirconia, erbium aluminum garnet (EAG), yttrium oxynitride, silicon oxynitride, forsterite, aluminium nitride, and silicon carbide.

In a preferred aspect A1 of the invention, the first layer of the layered body comprises YAG, more preferably comprises YAG in an amount of at least 90 vol-%, even more preferably at least 95 vol-%, and further preferably at least 99 vol-%, where the vol-% is based on a volume of the first layer. In this aspect A1, it is preferred that the first layer comprises YAG in an amount that is in the range from 90 to 99.9 vol-%, more preferably from 90 to 99.8 vol-%, even more preferably from 90 to 99.8 vol-%, further preferably from 90 to 99.8 vol-%, further preferably from 93 to 99.8 vol-%, further preferably from 93 to 99.7 vol-%, and even further preferably from 93 to 99.6 vol-%, where the vol-% is based on a volume of the first layer.

In a preferred aspect A2 of the invention, the layered body comprises a first layer and a further layer. In this aspect A2, it is preferred that the first layer comprises YAG, more preferably as described in the preceding aspect A1. In the aspect A2, it is preferred that the further layer comprises ZTA in an amount of at least 90 vol-%, even more preferably at least 95 vol-%, and further preferably at least 99 vol-%, where the vol-% is based on a volume of the further layer.

In another preferred aspect A3 of the invention, the first layer comprises aluminium nitride. In yet another preferred aspect A4 of the invention, the first layer comprises silicon carbide. In one or both of the aspects A3 and A4, it is preferred that the layered body comprises a first layer and a further layer, wherein the further layer comprises ZTA, more preferably as described in the aspect A2 above.

A preferred layered body is a ceramic body. A preferred ceramic is an inorganic material. A preferred ceramic is non-metallic. Some preferred ceramics are oxides, nitrides, carbides, or combinations thereof. A preferred ceramic is a refractory material.

A preferred oxide ceramic may be the oxide of a single element, or a mixed oxide of more than one element. An oxide ceramic may comprise some nitride or carbide content or both. An oxide ceramic may be free of nitride or free of carbide or free of both. A preferred oxide ceramic may be stoichiometric or non-stoichiometric. A stoichiometric oxide preferably has whole number ratios between the number of atoms of its constituent elements. An oxide ceramic may contain two or more groupings of elements, each element being in a stoichiometric ratio to each other elements of its own grouping, but in a non-stoichiometric ratio to each member of other groupings.

Some preferred mixed oxides are one or more selected from the group consisting of: zirconium silicate oxide, hafnium aluminate oxide, hafnium silicate oxide, titanium silicate oxide, lanthanum silicate oxide, lanthanum aluminate oxide (LAO), yttrium silicate oxide, titanium silicate oxide, tantalum silicate oxide, oxynitride, barium titanate, lead titanate and lead zirconate titanate.

Nitrogen-containing ceramics are often quantified in terms the content of simple nitrides which would be required to prepare them. Some preferred nitride constituents are one or more selected from the group consisting of: silicon nitride, titanium nitride, yttrium nitride, aluminium nitride, boron nitride, beryllium nitride and tungsten nitride.

A preferred nitride ceramic may be the nitride of a single element, or a mixed nitride of more than one element. A nitride ceramic may comprise some oxide or carbide content or both. A nitride ceramic may be free of oxide or free of carbide or free of both. A preferred nitride ceramic may be stoichiometric or non-stoichiometric. A stoichiometric nitride preferably has whole number ratios between the number of atoms of its constituent elements. A nitride ceramic may contain two or more groupings of elements, each element being in a stoichiometric ratio to each other elements of its own grouping, but in a non-stoichiometric ratio to each member of other groupings.

A preferred carbide ceramic may be the carbide of a single element, or a mixed carbide of more than one element. A carbide ceramic may comprise some oxide or nitride content or both. A carbide ceramic may be free of oxide or free of nitride or free of both. A preferred carbide ceramic may be stoichiometric or non-stoichiometric. A stoichiometric carbide preferably has whole number ratios between the number of atoms of its constituent elements. A carbide ceramic may contain two or more groupings of elements, each element being in a stoichiometric ratio to each other elements of its own grouping, but in a non-stoichiometric ratio to each member of other groupings.

A preferred layered body has a size of at least 200 mm, more preferably at least 300 mm, and further preferably at least 500 mm. The size of the layered body might reach as high as 2000 mm or more. In a preferred aspect of the invention, the size of the layered body is not more than 1500 mm, more preferably not more than 900 mm, even more preferably not more than 800 mm, further preferably not more than 700 mm, and even further preferably not more than 650 mm. In a preferred aspect of the invention, the size of the layered body is preferably in the range from 200 to 650 mm, more preferably from 300 to 650 mm, even more preferably from 400 to 650 mm, and further preferably from 500 to 650 mm. In a preferred aspect of the invention, the size of the layered body is in the range from 550 to 625 mm. In the above preferred aspects, the size of the layered body should be understood as the largest dimension (e.g., a diameter) of the layered body.

In a preferred aspect of the invention, the first layer is polycrystalline or crystalline. In another preferred aspect of the invention, if the layered body comprises a further layer, it is preferred that the further layer is polycrystalline or crystalline. A crystalline layer should preferably be understood as having a single crystal structure.

A layered body according to the invention is preferably used in plasma processing chambers.

### Heat Treatment of Layered Body

In one aspect of the invention, it is preferred to subject the layered body to a heat treatment. A preferred heat treatment of the layered body is an annealing of the layered body. A layered body subjected to a heat treatment may be referred to as a treated layered body. A layered body subjected to annealing may be referred to as an annealed layered body.

In a preferred aspect of the invention, a heat treatment of the layered body is performed at a temperature that is in the range from 900 to 1800° C., preferably 1000 to 1700° C., more preferably 1100 to 1600° C., even more preferably from 1200 to 1500° C., further preferably from 1300 to 1475° C., and even further preferably from 1350 to 1450° C.

In a preferred aspect of the invention, a heat treatment of a layered body is performed at a heating and/or cooling rate that is in the range from 0.05 to 50° C./min, more preferably from 0.1 to 25° C./min, even more preferably from 0.3 to 10° C./min, and further preferably from 0.5 to 5° C./min. In a preferred aspect of the invention, a heat treatment of a layered body is performed at a cooling rate that is in the range from 1 to 50° C./min, more preferably from 3 to 50° C./min, even more preferably from 5 to 50° C./min, and further preferably from 25 to 50° C./min. In a preferred aspect of the invention, a heat treatment of a layered body is performed at a heating rate that is in the range from 0.05 to 10° C./min, more preferably 0.1 to 5° C./min, even more preferably 0.3 to 2° C./min, and further preferably from 0.5 to 1° C./min.

In a preferred aspect of the invention, a heat treatment of a layered body is performed for a duration of 1 to 24 hours, more preferably 1 to 18 hours, even more preferably from 1 to 16 hours, and further preferably from 1 to 8 hours. A heat treatment of a layered body is preferably performed for a duration of 4 to 24 hours, more preferably 8 to 24 hours, and even more preferably 12 to 24 hours. A heat treatment of a layered body is preferably performed for a duration of 4 to 12 hours, and more preferably 6 to 10 hours.

A heat treatment of a layered body is preferably performed under oxidizing conditions such as forced convection or in air. A heat treatment of a layered body is preferably performed at ambient pressures.

A heat treatment of the layered body may be performed while the layered body is in the interior volume of the device. Alternatively, a heat treatment of the layered body may be performed outside of the interior volume of the device. For example, the layered body is removed from the interior volume of the device and placed in a further cavity, with the layered body subjected to the heat treatment in the further cavity.

An example of a further cavity is the cavity of a furnace. Any furnace which the skilled person deems suitable for the heat treatment of the layered body may be used. Such furnaces are well known to the skilled person. An example is a model STD-1200-17 industrial box furnace commercially available from JinYu Electric Material Co., Ltd. (Dengfeng City, China).

### Application of the Layered Body

In a preferred embodiment, the layered body disclosed herein can be machined into a process ring. Examples of a process ring include an insert ring, a focus ring, an exhaust ring, a cover ring, a deposition ring, an etch ring, a shield ring, a carrier ring, or a substrate capture ring that are components of a plasma vacuum processing chamber. Each process ring comprises: an annular body, wherein said body preferably comprises from 90% to 99.8% by volume of polycrystalline yttrium aluminum garnet, wherein the annular body has at least one surface having a surface area; and an opening surrounded by the annular body. Preferably, the polycrystalline yttrium aluminum garnet comprises pores on the at least one surface having a pore size not exceeding 5 μm and preferably having a maximum pore size of 1.5 μm for at least 95% of the pores.

In another preferred embodiment, the layered body disclosed herein can be machined into a “showerhead” gas flow manifold, also referred to as a showerhead assembly or a gas distribution assembly. This device is typically used to distribute process gases across the surface of a wafer. Process gases may be flowed out of the showerhead and distributed across a wafer; the wafer may be supported by a pedestal assembly within a process chamber housing the showerhead. Distribution of the process gases across the wafer may be accomplished through a pattern of gas distribution holes which direct the flow of gas from inside the showerhead assembly to the wafer.

A showerhead assembly typically comprises: a backplate portion comprising at least one gas inlet; a front-plate portion opposite the backplate portion, wherein the front-plate portion comprises a plurality of gas distribution holes; and an inner volume in communication with the gas distribution holes and the gas inlet. Preferably, the backplate portion and the front-plate portion each comprise from 90% to 99.8% by volume of polycrystalline yttrium aluminum garnet and have at least one surface, wherein the polycrystalline yttrium aluminum garnet preferably comprises pores on the at least one surface, and wherein the pores preferably have a pore size not exceeding 5 μm and preferably have a maximum pore size of 1.5 μm for at least 95% of the pores.

In preferred embodiment, the layered body disclosed herein can be machined into a gas distribution nozzle comprising: a body having at least one gas injection passage and at least one surface having a surface area, wherein the body preferably comprises from 90% to 99.8% by volume of polycrystalline yttrium aluminum garnet, wherein the polycrystalline yttrium aluminum garnet preferably comprises pores on the at least one surface, and wherein the pores preferably have a pore size not exceeding 5 μm and preferably have a maximum pore size of 1.5 μm for at least 95% of the pores.

In still another embodiment, the layered body disclosed herein can be machined into a dielectric window, preferably through which RF or microwave energy passes when used in a plasma process chamber. The dielectric window comprises: a body having at least one surface having a surface area, wherein the body preferably comprises from 90% to 99.8% by volume of polycrystalline yttrium aluminum garnet, wherein the polycrystalline yttrium aluminum garnet preferably comprises pores on the at least one surface, and wherein the pores preferably have a pore size not exceeding 5 μm and preferably have a maximum pore size of 1.5 μm for at least 95% of the pores.

The dielectric window disclosed herein may be a single layer or it may have more than one layer (i.e., a multilayer dielectric window) as long as it allows for the transmission of radiation/energy. The dielectric window, if multilayer, may comprise at least one layer comprising a material other than YAG. Exemplary materials include alumina or quartz. The dielectric window may have any shape such as, for example, a disk shape, or a circular shape and be sufficiently large enough to form the ceiling of the process chamber.

### Figure Descriptions

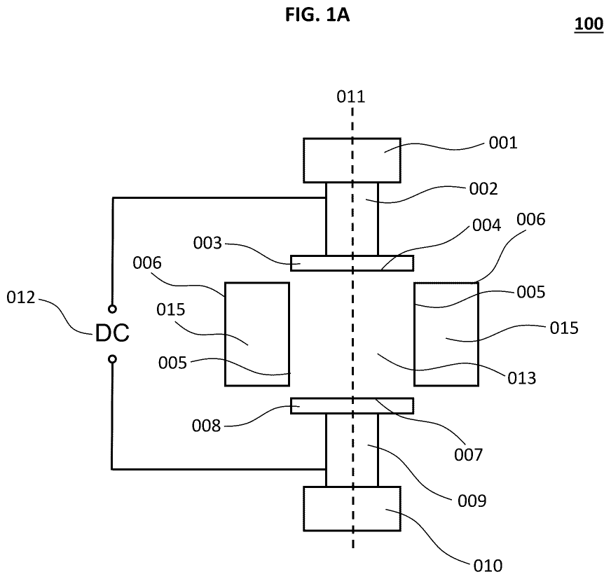

FIG. 1A shows a cross-sectional side-view of a device 100 according to the invention. The device has a first punch 003 having a first punch interior surface 004 and a second punch 008 having a second punch interior surface 007. The punches 003 and 008 are made of solid graphite. The punch interior surfaces 004 and 007 are thus also of graphite. The first punch 003 is positioned above the second punch 008. The first punch 003 is oriented with the first punch interior surface 004 being horizontal and facing downwards. The first punch 003 can be moved in a vertical direction by a first pushing means 001 connected via a first piston 002. The second punch 008 is oriented with the second punch interior surface 007 being horizontal and facing upwards. The second punch 008 can be moved in a vertical direction by a second pushing means 010 connected via a second piston 009. The first 004 and second 007 punch interior surfaces can thus be moved towards each other along the direction of a compression axis 011.

The device has a die 006 shaped as a hollow graphite cylinder with a wall 015 and an interior surface 005. The device has an electrical power source 012 that is adapted and arrange to supply a direct current (DC). The electrical power source 012 is electrically connected to the first 003 and second 008 punches. An interior volume 013 is defined (or bordered) by the first punch interior surface 004 from above, the second punch interior surface 007 from below, and the interior surface 005 to the die 006. In the case of FIG. 1A, both punch interior surfaces 004 and 007 are circular while the interior surface 005 is cylindrical. The interior volume 013 is thus also cylindrical.

FIG. 1B shows a cross-sectional side-view of the device of FIG. 1A with the interior volume 013 loaded and ready for sintering. The interior volume 013 is filled with a first powder for sintering, wherein the first powder is arranged to form a first powder layer 014. Prior to sintering, the punch interior surfaces 004 and 007 are moved inwards to abut against the first powder layer 014. The punch interior surfaces 004 and 007 are moved inwards along the compression axis 011 as shown by the arrows. During sintering, the punch interior surfaces 004 and 007 apply a force to the first powder layer 014, thus creating a pressure in the interior volume 013. During sintering, an electrical voltage is also applied across the interior volume 013 (between the first punch interior surface 004 and the second punch interior surface 007) and/or the die 006. The electrical voltage is obtained using the electrical power source 012. As a result of the application of the electrical voltage, a heat is generated in the interior volume 013. As a result of subjecting the first powder layer 014 to the heat and pressure, the first powder layer 014 is sintered, and a layered body is obtained thereby. When the sintering process is complete, the layered body is allowed to cool. During cooling, the punches 003 and 008 are retracted (i.e., no pressure is applied to the layered body by the punches). During cooling, the electrical voltage is also removed.

Although only the first powder layer 014 is shown in FIG. 1B, one or more additional powders may also be introduced into the interior volume 013 prior to sintering. For example, once the first powder layer 014 has been obtained, a further powder is introduced into the interior volume 013 to obtain a further powder layer. The further powder layer is above the first powder layer 014 and is also in contact with the first powder layer 014. During sintering, the pressure in the interior volume 013 is applied to both the first powder layer 014 and the further powder layer. The further powder layer is also subjected to the heat along with the first powder layer. As a result of subjecting the first powder layer 014 and the further powder layer to the heat and pressure, the first powder layer 014 and the further powder layer are sintered, and a layered body is obtained thereby. The layered body comprises a first layer and a further layer. The first layer is obtained from the first powder layer and a further layer is obtained from the further powder layer.

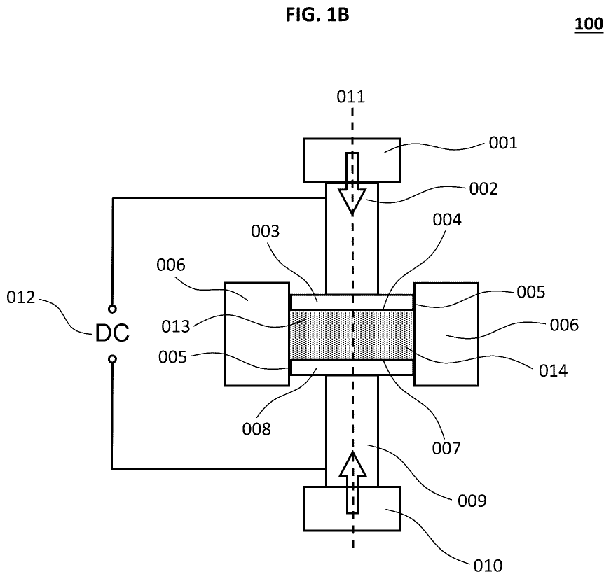

FIG. 2 is a flow diagram showing the steps of a process 200, according to the invention, for producing a layered body. In step 201, a first powder is introduced into an interior volume of a device to obtain a first powder layer in said interior volume. The interior volume is bordered by an interior surface of a die, a first punch interior surface of a first punch, and a second punch interior surface of a second punch. The interior volume has a cross-sectional width of at least 200 mm. The die, as well as the first punch and the second punch, are made from graphite. The device is adapted and arranged for spark plasma sintering. The first powder is a mixture comprising a first constituent powder and a further constituent powder, wherein the first constituent powder and the further constituent powder have different chemical compositions. Furthermore, the further constituent powder, of the first powder, has a particle size distribution D=q(χ) of volume density q over particle size χ, such that D has a first local maximum α at particle size χ_{α} with volume density q_{α}, D has a second local maximum β at particle size χ_{β} with volume density q_{β}, χ_{α}>χ_{β}, and q_{α}/q_{β} is at least 1. In step 202, the first powder layer is subjected to a heat and a pressure to obtain a layered body. The heat is generated by an electrical voltage applied across the die, the interior volume, or both. The layered body comprises a first layer.

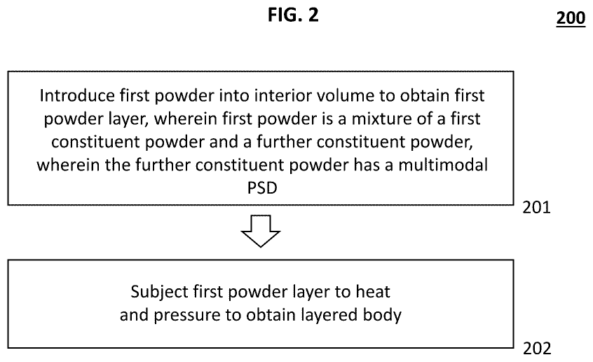

FIGS. 3A and 3B show the core test 300 employed herein. FIG. 3A shows a perspective view prior to commencement of the test. A coring tool 301 is positioned above a first flat surface 302 of a layered body 306. In FIG. 3A the layered body 306 is a flat-form layered body, and is in the form of a cylindrical disc. The tool 301 is oriented along an axis perpendicular to the first flat surface 302. The arrow 308 shows the direction of the travel of the tool 301 along the axis towards the layered body 306. Once in contact with the layered body 306, the coring tool 301 moves in a circular motion inside a coring region 307 that has a diameter that is larger than a diameter of a tip 309 of the coring tool 301. The circular motion is parallel to the first flat surface 302 and leads to the removal of a cylindrical region (or core) from the layered body 306. Furthermore, a geometric center 305 of the first flat surface 302 is also the geometric center 305 of the coring region 307. FIG. 3B shows a cutaway view from the side during the core test. The tool 301 has advanced a distance 303 into the layered body 306, which has a sample thickness 304. FIG. 3B shows that the coring tool 301 has removed a cylindrical section 310 from the layered body 306. The distance 303 is determined between the first flat surface 302 and the end of the tool 301. The test finishes at the first observation of cracks in the layered body 306. The success level is determined as the ratio of the distance cored 303 to the total thickness of the layered body 306 at the end of the test, expressed as a percentage.

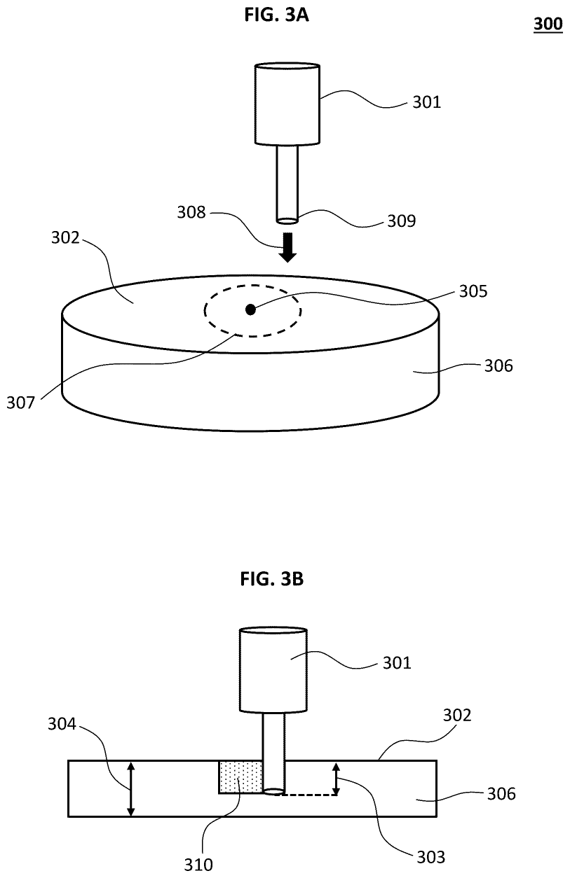

FIG. 4 shows how to measure an angle of repose of a powder. A mesh basket strainer 401 is affixed at a distance 402 above a working surface 403. The strainer 401 is positioned such that the center of the strainer 404 is above the center of the working surface 403. Powder 405 is added to the strainer 401 and allowed to flow through the strainer 401 (as indicated by the arrow in FIG. 4). As a result, the powder collects on the working surface 403 in the form of a cone-like shape 406. Once the strainer 401 has been emptied, a tangent line 407 is fitted to a side of the cone-like shape 406 and the angle 408 enclosed between the tangent line 407 and the working surface 403 is measured using a protractor. This angle 408 is an angle of repose of the powder.

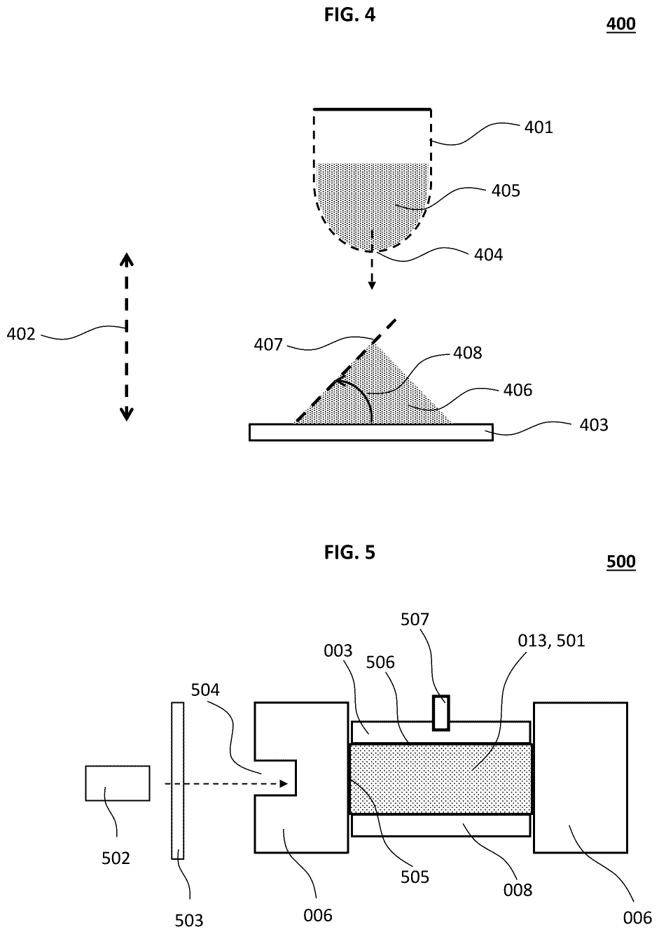

FIG. 5 shows how the temperatures of the side and top of the layered body are measured. FIG. 5 shows the die 006, first punch 003, and the second punch 008 forming the interior volume 013. A layered body 501 is present in, and occupies, the interior volume 013. In FIG. 5, the interior volume 013 is located in the sintering device. A pyrometer 502 is also located in the sintering device. Between the pyrometer 502 and the interior volume 013 is an observation window 503 made of quartz. FIG. 5 also shows that one side of the die 006, said side facing the pyrometer 502, has a recess 504. The pyrometer 502 is used to measure the temperature in the recess 504. The temperature of the recess 504 is defined as the temperature of the side 505 of the layered body 501. The temperature at the top 506 of the layered body 501 is measured using a thermocouple 507. The thermocouple 507 is located in the center of the first punch 003 (at the position of the compression axis 011—see FIG. 1).

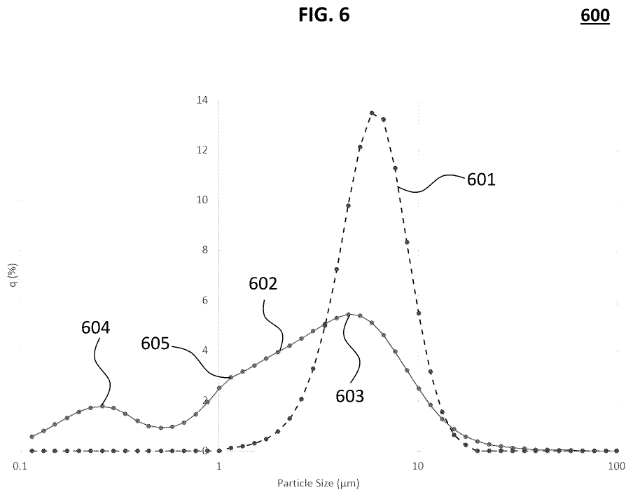

FIG. 6 shows the particle size distributions (PSDs) of the first constituent powder and the further constituent powder of the first powder. The first constituent powder (in this case yttria) has a monomodal PSD 601. The further constituent powder (in this case alumina) has a multimodal PSD 602. The multimodal PSD 602 has a first local maximum 603 (a first local maximum α at particle size χ_{α} with volume density q_{α}). The multimodal PSD 602 also has a second local maximum 604 (a second local maximum β at particle size χ_{β} with volume density q_{β}). Preferably, the multimodal PSD 602 also has a third local maximum 605 (third local maximum γ at particle size χ_{γ} with volume density q_{γ}) located between the global maximum 603 and the second local maximum 604. The local maximum 603, the local maximum 604, and any additional local maxima, are referred to as modes of the PSD 602. As can be seen from FIG. 6., the local maximum 603 is a global maximum (i.e., the local maximum 603 has a large q-value compared to the q-value of the second local maximum 604).

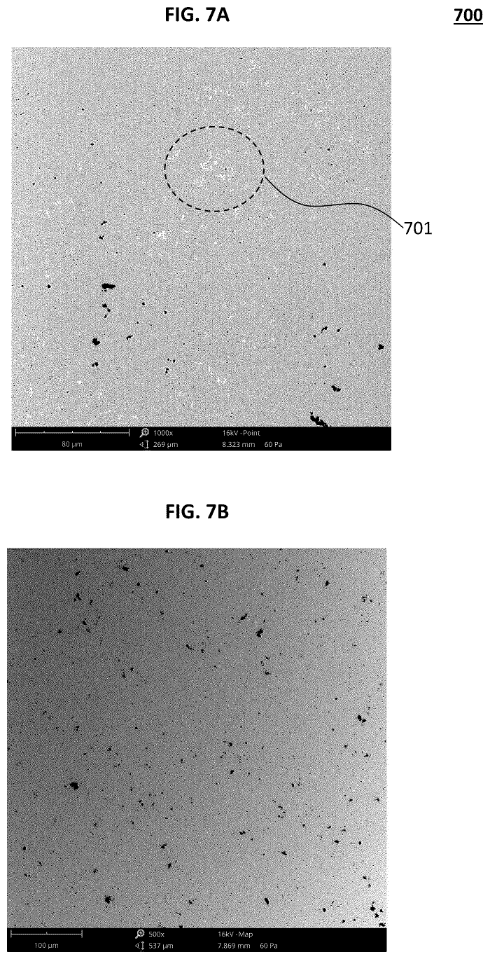

FIGS. 7A and 7B show scanning electron microscope images of first layers of layered bodies obtained using different PSDs for the further constituent powder of the first powder. The first layers are made from YAG and are obtained from a first powder that is a mixture of yttria (the first constituent powder) and alumina (the further constituent powder). The YAG layer in FIG. 7A was obtained using alumina with a PSD that is not according to the invention. Numerous areas of unreacted yttria (i.e., yttria that has not reacted with the alumina to form YAG) are visible as white spots in the image. Such an area is in indicated by the dashed circle 701. The YAG layer in FIG. 7B was obtained using alumina with a PSD that is according to the invention. Compared to FIG. 7A, it can be seen that the number of areas of unreacted yttria is significantly reduced in FIG. 7B.

### TEST METHODS

The test methods which follow were utilized within the context of the invention. Unless stated otherwise, the measurements were conducted at an ambient temperature of 23° C. and an ambient air pressure of 100 kPa (0.986 atm).

### Carbon Content and Content of Other Elements

The carbon content of a powder is expressed in ppm by weight, based on a total weight of the powder. The carbon content is measured using an EMIA Series carbon/sulfur analyzer, model EMIA-Expert, commercially available from Horiba Instruments Inc. (USA). The carbon content is analyzed by placing 0.5 grams of the powder in a crucible, with the crucible in turn placed in the carbon/sulfur analyzer. Prior to placing the powder in the crucible, the crucible is heated to at least 1000° C. for 60 minutes in a muffle furnace. Thereafter, the crucible is removed from the furnace and placed in a desiccator. The crucible is allowed to return to room temperature prior to placing the powder sample in said crucible.

Regarding the content of other elements in the powder: the sulfur content of a powder is expressed in ppm by weight, based on a total weight of the powder. The same carbon/sulfur analyzer and measurement method used for carbon is also used for measuring the sulfur content of a powder. The chlorine content of a powder is expressed in ppm by weight, based on a total weight of the powder. Chlorine content of a powder is measured using inductively coupled plasma mass spectrometry (ICP-MS), as described below. For this measurement, an Agilent 7900 ICP-MS (model G8403), commercially available from Agilent Technologies, Inc. (USA), is used.

A sample of powder is placed in a 15 ml vial. The powder is then dissolved using one or more acids with the addition of heat applied via microwave radiation. The amount of powder used is indicated in the table below. The amount of acid used is selected to be sufficient to dissolve the powder and to obtain a solution. The solution in the vial should not exceed 10 ml. For the application of the heat, an ultraWave single reaction chamber microwave is used. The heat is applied for 50 minutes, during which time the temperature of the solution should be 240±10° C. for at least 25 minutes.

TABLE
Amount of powder and acids used for measurement

| Powder | Acid |
|---|---|
| Yttria (Y₂O₃): 36 mg | HNO₃ |
| Alumina (Al₂O₃): 40 mg | HNO₃ |
| Al₂O₃—Y₂O₃ mixture: 40 mg | HNO₃ + H₂SO₄ + H₃PO₄ + HF |
| YAG (Y₃Al₅O₁₂): 40 mg | HNO₃ + H₂SO₄ + H₃PO₄ + HF |
| Zirconia (ZrO₂): 36 mg | HNO₃ + H₂SO₄ + H₃PO₄ + HF |
| ZrO₂—Y₂O₃ mixture: 36 mg | HNO₃ + H₂SO₄ + H₃PO₄ + HF |
| Magnesium oxide (MgO): 36 mg | HNO₃ |

For powders not indicated in the above table, the powder amount and acids as indicated for zirconia is used.

Once the powder has been dissolved, the vial is swirled for 10 seconds and placed in the Agilent 7900 ICP-MS for the chlorine content measurement. The ICP-MS takes a sample from the vial, nebulizes the sample to form an aerosol, and subjects the aerosol to a plasma. The ICP-MS then counts the resulting ions using a mass spectrometer.

For the measurement, the argon gas regulator in the Agilent 7900 ICP-MS is set to 100 psi, the helium gas regulator is set to 10 psi, and the nitrogen gas regulator is set to 10 psi. Furthermore, the plasma used to perform the measurement is allowed to warm up for 30 minutes prior to performing the measurement. The Agilent 7900 ICP-MS also has a Chiller that is set to 55 psi and 15° C.

### Water Content of Powder

The water content of a powder is measured using an i-Thermo G163L moisture analyzer, commercially available from BEL Engineering srl (Monza, Italy).

### Purity of Powders and Constituent Powders

The purity of the powders and constituent powders (e.g., alumina, yttria) is measured using inductively coupled plasma mass spectrometry (ICP-MS). Purity is reported herein as a percent relative to 100% purity, which represents a material comprising the intended constituents only, without impurities, dopants, sintering aids and the like.

### Angle of Repose

An angle of repose of a powder is measured as described in FIG. 4. The distance between the strainer and the working surface is between 17.78 and 20.32 cm (7 to 8 inches). The working surface is circular with a diameter of 20.32 cm (8 inches). An angle of repose is measured at 10, evenly spaced positions around the circumference of the working surface. The average of these 10 measurements is defined as the angle of repose of the powder, as claimed herein.

### Specific Surface Area

The specific surface area of a powder is measured according to the standard ASTM C1274. For the measurement, a Horiba BET Surface Area Analyzer model SA-9601, capable of measuring across a specific surface area of 0.01 to 2000 m²/g, is used.

### Particle Size

Particle sizes for the powders, constituent powders and powder layers are measured using a Horiba model LA-960 Laser Scattering Particle Size Distribution Analyzer capable of measuring particle size from 10 nm to 5 mm. The particle size measurement is performed by adding a 1 g sample of the powder, along with one drop of Na₄P₂O₇ (taken with a pipette), to de-ionized water in the Horiba model LA-960 Analyzer. During the measurement, circulation, agitation, and ultrasound are enabled in said analyzer. For the measurement, the circulation and agitation are both set to 5, and the ultrasound is used for 12:00 minutes at a power of 6.

The particle size measurement is also used to obtain a particle size distribution of a powder and a constituent powder. Particle size and particle size distributions are volume-based, e.g., the values of d₁₀, d₅₀ and d₉₀ are volume based.

### Core Test

A layered body is cored to determine if there is excess internal stress. The layered body is a flat-form layered body having a first flat face and a thickness perpendicular to the first flat face. A 10 mm diamond coring tool commercially available from, e.g., Schott Diamantwerkzeuge GmbH of Stadtoldendorf, Germany, is employed. The coring tool is used in commercially available CNC machines to remove a core in the layered body under test. The hole formed in the layered body, by removing the core, is from 56 mm to 60 mm and has a nominal diameter of 58 mm. The core is removed by passing the tool over the surface of the layered body in a helical pattern to bore a hole in the layered body. Suitable CNC machines that can be used for this test are available from, e.g., DMG Mori Company Limited of Los Angeles, California, USA, such as its Ultrasonic 60 eVo linear model. Another provider of suitable CNC machines is Fair Friend Ent. Co. Ltd. Of Taiwan, such as the Feeler HV-1650 model. The test concludes either when the core extends all the way through the layered body or when the layered body is observed to crack, whichever occurs first. The success score is given as the percentage of the thickness of the core cut in the layered body under test. 100% success rating indicates low internal stress if any; above 75% but below 100% success rating indicates low internal stress; 25% to 75% success rating indicates corresponds to medium stress; lower than 25% success rating indicates high internal stress. The above test method is further illustrated in FIGS. 3A and 3B.

### Volumetric Porosity

The volumetric porosity of the layered body, as well as a layer of the layered body, is calculated from density measurements performed in accordance with ASTM B962-17 if the volumetric porosity is 2% or higher. If the volumetric porosity is less than 2%, the measurement is performed according to the standard ASTM B311-17.

### Grain Size

Average grain size is measured using the linear intercept grain size measurements, in accordance with the Heyn Linear Intercept Procedure described in ASTM standard E112-2010.

### Color of the Layered Body

The CIELAB color coordinates of the layered body is determined using a WR-18 colorimeter commercially available from FRU (China).

### Etch Resistance

To determine the etch resistance of a layer (e.g., the first layer) of the layered body, 100 samples of the layer are selected. Each sample has a width and length of 6 mm×6 mm, and a thickness of 2 mm. Each sample is mounted onto a c-plane sapphire wafer using a silicone-based heat sink compound. Regions of a sample is blocked from exposure to the etch process by bonding a 5 mm×5 mm square sapphire ceramic to the sample surface.

A dry etch process is then performed for each sample using a Versaline DESC PDC Deep Silicon Etch, commercially available from Plasma-Therm (USA). The etch process is performed using a pressure of 10 millitorr, a bias of 600 volts and ICP power of 2000 watts. Furthermore, the etching is performed using a 2-step process for a total duration of 6 hours. The first etch step has a CF₄ flow rate of 90 standard cubic centimeters per minute (sccm), an oxygen flow rate of 30 standard cubic centimeters per minute (sccm), and an argon flow rate of 20 standard cubic centimeters per minute (sccm). The second etch step has an oxygen flow rate of 100 standard cubic centimetres per minute (sccm) and an argon flow rate of 20 standard cubic centimetres per minute (sccm). The first and second etch steps are performed for 300 seconds each and repeated for a combined duration of 6 hours. Upon completion of the etch process, surface roughness parameters Sa, Sz and Sdr are measured using the methods as disclosed herein.

### Surface Roughness

The surface roughness parameters Sa, Sz and Sdr are measured according to the standard ISO 25178-2:2012, section 4.1.7.

### Density and Theoretical Density of Layered Body

The density of the layered body is measured according to the standard ASTM B962-17. The theoretical density is calculated from x-ray diffraction (XRD) data. From the XRD data, the unit cell parameters a, b and c are obtained. Using the unit cell parameters, the unit cell volume is calculated. Based on the crystal structure of the material, the number of molecular units present in every unit cell is determined. The molecular weight of the layered body is known as its chemical structure is known. Using the foregoing data, the theoretical density is calculated as follows:

$$Theoretical density = ( Molecular weight \times No . of molecules per unit cell ) / ( Volume of unit cell \times Avogadro ' s number ) .$$

### Fracture Toughness

Fracture toughness is determined according to the standard ASTM E1820-18.

### Flexural Strength

Flexural strength is determined according to the standard ASTM C1161-18.

### Temperature

The temperature of the side of the layered body is determined as described in FIG. 5.

The measurement of the temperature in the recess of the die is made using a Model E2MH-R08-V-0-0 pyrometer commercially available from Fluke Process Instruments. The recess is 1.27 cm (0.5 inches) in diameter. The recess extends to a depth of 13.46 cm (5.3 inches) into the wall of the die. The thickness of the wall, measured at a position of the recess, is about 15.24 cm (6 inches). The pyrometer is located at a distance of 30.48 cm (12 inches) from the recess.

The temperature at the top of the layered body is measured as described in FIG. 5. For the measurement a thermocouple, Model A14A-N51700-1 commercially available from Nanmac Corporation (USA), is used.

The thermocouple is at a distance of between 15.24 to 20.32 cm (6 to 8 inches) from the top of the layered body.

The temperature in the interior volume is measured using the same thermocouple that is used to measure the temperature of the top of the layered body. I.e., the temperature of the interior volume and the temperature of the top of the layered body (once the layered body has formed) is the same measurement.

The temperature used for the calcining of a (constituent) powder is obtained using a digital readout on the kiln used for the calcining process.

The temperature of an environment (i.e., outside the interior volume), such as a storage room, is measured using an EXTECH Video Particle Counter (0.3, 0.5, 1.0 2.5, and 10 μm).

### Pressure

The force in the interior volume is measured using a load cell commercially available from Interface Force Measurement Solutions (USA). The load cell used is a Model 1290CHG-2000K having a capacity of 2000 Klbf. The pressure in the interior volume is then calculated based on force divided by area of the interior volume. The area of the interior volume is given by π(D_{INT}/2)², where D_{INT} is the diameter of the interior volume.

### EXAMPLES

The invention is illustrated further by way of examples. The invention is not restricted to the examples. In the tables of the examples, the size of an effect is indicated by one or more “+” or “−”. The following scale is used: “−−−−−”, “−−−−”, “−−−”, “−−”, “−”, “+”, “++”, “+++”, “++++”, “+++++”. A reference value is indicated by “Ref”. No change with respect to a reference value is indicated by “0”.

### Basic Set-Up

Unless specified otherwise, the basic set-up described below applies to all examples.

Two constituent powders are provided, wherein the first constituent powder is yttria powder and the further constituent powder is alumina powder. The yttria has a d₁₀ particle size that is in the range from 2 to 4 μm, a d₅₀ particle size that is in the range from 6 to 8 μm, and a d₉₀ particle size that is in the range from 11 to 13 μm.

The alumina and yttria are mixed, using wet ball milling, to obtain a first powder. The wet ball mixing is done using high purity (>99.9%) alumina media and in which the alumina media weight is from about 90% to about the same as the powder weight, i.e., around 50% loading. A slurry is formed by adding ethanol to the alumina and yttria, with the ethanol making up about 40 wt-% to 50 wt-% of the total slurry weight (weight of ethanol and first powder together). The slurry was mixed for about 15 to 20 hours at 150 RPM. Following the milling, ethanol is extracted from the slurry using a rotary evaporator. The dried powder is then tumbled and sieved according to methods known to those skilled in the art to obtain the first powder. The first powder is subsequently calcined (subjected to a heat treatment) at 800° C. to 1050° C. for 7 hours depending on vessel size (larger vessels require more calcining time). After calcining, the first powder has a d₅₀ particle size that is in the range from 9 to 13 μm, while the first powder has in the range from 42.9 to 43.4 wt-% alumina and in the range from 56.6 to 57.1 wt-% yttria, based on a total weight of the first powder.

Two further constituent powders are provided, wherein the first constituent powder is partially stabilized zirconia powder, and the further constituent powder is alumina powder. The alumina has a d₁₀ particle size that is in the range from 0.05 to 0.15 μm, a d₅₀ particle size that is in the range from 0.2 to 0.5 μm, and a d₉₀ particle size that is in the range from 0.4 to 1 μm. The zirconia has a d₁₀ particle size that is in the range from 0.08 to 0.2 μm, a d₅₀ particle size that is in the range from 0.2 to 0.5 μm, and a d₉₀ particle size that is in the range from 0.5 to 1.2 μm.

The alumina and zirconia are mixed, using wet ball milling, to obtain a further powder. The wet ball mixing is done using high purity (>99.9%) alumina media and using about 80% loading relative to powder weight. A slurry is formed by adding ethanol to the alumina and yttria, with the ethanol making up about 50 wt-% of the total slurry weight. The slurry was mixed for about 20 hours at 20 RPM. Following the milling, ethanol is extracted from the slurry using a rotary evaporator. The dried powder is then tumbled and sieved according to methods known to those skilled in the art to obtain the further powder. The further powder is subsequently calcined (subjected to a heat treatment) at 900° C. for 7 hours depending on vessel size (smaller vessels require less time). After calcining, the further powder has a d₅₀ particle size that is in the range from 90 to 110 μm, while the first further has in the range from 77.1 to 78.3 wt-% alumina and in the range from 21.7 to 22.9 wt-% zirconia, based on a total weight of the further powder. Alternatively, the alumina and zirconia may be jet milled, rather than wet ball milled.

The first powder is introduced into an interior volume of the device shown in FIG. 1 (a spark plasma sintering device). The first powder is spread evenly to obtain a first powder layer. The further powder is subsequently introduced into the interior volume by placing the further powder on the first powder layer. The further powder is spread evenly to obtain a further powder layer on the first powder layer. The first powder and the further powder are introduced while the interior volume is removed from the device. The interior volume is subsequently placed in a sintering chamber of the device, and the interior volume is evacuated in order to obtain a pressure in the range from 10⁻³ to 10⁻² torr in the interior volume.

The first powder layer and the further powder layer are subjected to a heat and a pressure. During said step of subjecting the first and further powder layers to the heat and pressure, the temperature and the pressure in the interior volume are increased to 1625° C. and 15 MPa, respectively. The first and further powder layers are subjected to a temperature of 1625° C. and a pressure of 15 MPa for 60 to 75 minutes. Thereafter, the sintering chamber is filled with an inert gas, preferably nitrogen, and allowed to cool for several hours. The layered body obtained has a first layer and a further layer that are adjacent to each other (i.e., touch each other). The first layer is made from YAG, and the further layer is made from ZTA. The application of the heat and pressure to the first powder layer leads to the alumina and yttria reacting to form the YAG layer of the layered body. Similarly, the application of the heat and pressure to the further powder layer leads to the alumina and zirconia forming the ZTA layer of the layered body.

Once the layered body has a temperature of around 25° C., the layered body is removed and placed in a furnace under normal atmospheric pressure and oxygen content. The layered body is then subjected to a heat treatment for a duration of 8 hours at a temperature of 1400° C.

### Example 1

In Example 1, the interior volume of the device has a cross-sectional width of 600 mm. The layered bodies produced consequently also have diameters of 600 mm. Furthermore, the first layers of the layered bodies are made from YAG and have a thickness of 5 mm.

The further constituent powder, of the first powder, has a particle size distribution D=q(χ) of volume density q over particle size χ, such that
I./ D has a first local maximum α at particle size χ_{α}=4.3 μm with volume density q_{α};
II./ D has a second local maximum β at particle size χ_{β}=0.24 μm with volume density q_{β},
III./ χ_{α}>χ_{β}, and
IV./ q_{α}/q_{β} has the values as indicated in Table 1.

The first constituent powder, of the first powder, has a particle size distribution E=r(χ) of volume density r over particle size χ, and wherein E has a global maximum δ at particle size χ_{δ} with volume density r_{δ}, and wherein the following applies: χ_{δ}=5.4 μm; r_{δ}=0.12; and E is monomodal.

TABLE 1

| Example | 1.1 | 1.2 | 1.3 | 1.4 | 1.5 | 1.6 | 1.7 |
|---|---|---|---|---|---|---|---|
| Set-up | | | | | | | |
| q_{α}/q_{β} | 0.8 | 1.1 | 2 | 3 | 5 | 10 | 14 |
| Layered body produced | | | | | | | |
| Strength | −− | ++ | ++ | ++ | ++ | + | −− |
| Scratch resistance | −− | ++ | ++ | ++ | ++ | + | −− |
| Density variation | −−− | + | ++ | ++ | ++ | + | −− |
| Core test success rate [%] | −−− | + | ++ | ++ | ++ | + | − |
| Etch resistance | −−− | + | + | + | + | + | −− |
| Porosity | −−− | + | + | + | + | + | −− |
| Unreacted constituent powders | ++ | − | −− | −− | −− | − | ++ |
| [vol-%] | | | | | | | |

The technical effects in Table 1 are the following:
Strength: the external force or external stress required to permanently deform or break the layered body, and in particular the first layer, when said external force or external stress is applied to the layered body. A “+” indicates a larger strength, and a “−” indicates a smaller strength. It is desired to have an increased strength.
Scratch resistance: the resistance of the layered body, and in particular the first layer, to scratches. A “+” indicates a larger scratch resistance, and a “−” indicates a smaller scratch resistance. It is desired to have an increased scratch resistance.
Density variation: the variation in density in the layered body, and in particular the first layer. A “+” indicates a larger density variation, and a “−” indicates a smaller density variation. It is desired to decrease the density variation.
Core test success rate: the percentage of layered bodies that pass the core test. A layered body fails the core test if it cracks or breaks when subjected to the core test. A “+” indicates a larger core test success rate, and a “−” indicates a smaller success rate. It is desired to have a larger core test success rate.
Etch resistance: the resistance of the layered body to chemical etchants, in particular the first layer made from YAG. A “+” indicates a larger resistance, and a “−” indicates a smaller resistance. It is desired to have a larger resistance.
Porosity: the volumetric porosity of the layered body, and in particular the first layer. A “+” indicates a larger volumetric porosity, and a “−” indicates a smaller volumetric porosity. It is desired to have a smaller volumetric porosity.
Unreacted constituent powders: the amounts of alumina and yttria that are present in the first layer of the layered body. A “+” indicates that larger amounts of the constituent powders alumina and yttria are present in the first layer, and a “−” indicates that smaller amounts are present. It is desired to reduce the amounts of constituent powders in the first layer of the layered body.

In a variation of Example 1, the example was repeated for a set-up that only has the first powder layer (i.e., a further powder layer is not introduced into the interior volume). The layered body subsequently obtained therefore has only a single YAG layer. Results similar to those shown in Table 1 were also obtained for the single-layer body.

### Example 2

Example 1.4 was repeated, but for different thickness of the first layer of the layered body that is produced. Apart from the thickness of the first layer, the set-up of Example 2 is the same as that of Example 1.4. The results of Example 2 are shown in Table 2 below.

TABLE 2

| Example | 2.1 | 2.2 | 2.3 | 2.4 | 2.5 | 2.6 | 2.7 |
|---|---|---|---|---|---|---|---|
| Set-up | | | | | | | |
| Thickness of first layer [mm] | 1 | 3 | 5 | 10 | 20 | 30 | 50 |
| Layered body produced | | | | | | | |
| Strength | ++ | ++ | ++ | + | −− | −− | −−− |
| Scratch resistance | + | + | + | − | − | − | − |
| Density variation | − | − | − | + | + | + | + |
| Core test success rate [%] | + | + | + | − | − | − | − |
| Etch resistance | + | + | + | − | − | − | −− |
| Porosity | − | − | − | + | + | + | + |
| Unreacted constituent powders | − | − | − | + | + | ++ | ++ |
| [vol-%] | | | | | | | |

The technical effects in Table 2 are as described for Table 1.

### REFERENCE LIST

100 Device according to the invention
001 First pushing means
002 First piston
003 First punch
004 First punch interior surface
005 Interior surface of die
006 Die
007 Second punch interior surface
008 Second punch
009 Second piston
010 Second pushing means
011 Compression axis
012 Electrical power source
013 Interior volume
014 First powder layer
015 Die wall
200 Process for producing a layered body
201 Introduce first powder into interior volume to obtain first powder layer, wherein first powder is a mixture of a first constituent powder and a further constituent powder, wherein the further constituent powder has a multimodal PSD
202 Subject first powder layer to heat and pressure to obtain layered body
300 Core test setup
301 Coring Tool
302 First flat surface
303 Drill depth
304 Sample thickness
305 Geometric center
306 Flat-form layered body
307 Coring region
308 Direction of motion perpendicular to flat-form layered body
309 Tip of coring tool
310 Cylindrical section removed from flat-form layered body
400 Angle of repose measurement
401 Strainer
402 Distance between funnel and working surface
403 Working surface
404 Funnel outlet
405 Powder added to funnel
406 Powder collected in the form of cone-like shape
407 Tangent line
408 Angle of repose
500 Measurement of temperatures of side and top of layered body
501 Layered body
502 Pyrometer
503 Observation window
504 Recess in die
505 Side of layered body
506 Top of layered body
507 Thermocouple
600 Particle size distributions of constituent powders of first powder
601 Particle size distribution of first constituent powder
602 Particle size distribution of further constituent powder
603 Global maximum (first local maximum)
604 Second local maximum
605 Third local maximum
700 Images of YAG layer of layered body
701 Areas of unreacted yttria

1. A process for producing a layered body, comprising:
a. introducing a first powder into an interior volume to obtain a first powder layer in the interior volume, wherein
i. the interior volume
A. has a cross-sectional width W of at least 200 mm, and
B. is at least partially bordered by an interior surface of a die, wherein the die has at least one wall, and wherein said wall comprises carbon;
ii. the first powder is a mixture comprising a first constituent powder and a further constituent powder, wherein the first constituent powder and the further constituent powder have different chemical compositions;
b. subjecting the first powder layer to a heat and a pressure to obtain the layered body, wherein
i. the heat is generated by an electrical voltage applied across the die, the interior volume, or both, and
ii. the layered body comprises a first layer;
wherein
the further constituent powder, of the first powder, has a particle size distribution D=q(χ) of volume density q over particle size χ, such that
I./ D has a first local maximum α at particle size χ_{α} with volume density q_{α},
II./ D has a second local maximum β at particle size χ_{β} with volume density q_{β},
III./ χ_{α}>χ_{β}, and
IV./ q_{α}/q_{β} is at least 1.

2. The process according to claim 1, wherein the first powder comprises at least one or all of the following: yttrium, aluminium, zirconium, magnesium, a combination of at least two thereof.

3. The process according to claim 1, wherein the first powder is capable, under the application of heat and pressure, of forming at least one or all of the following:
a. an oxide A comprising at least 1 mol-% of an element of the 3^{rd} group (former group IIIB) and at least 1 mol-% of an element of the 13^{th} group (former group IIIA), wherein the mol-% is based on the oxygen in the oxide A;
b. an oxide B comprising at least 1 mol-% of an element of the 4^{th} group (former group IVB) and at least 1 mol-% of an element of the 13^{th} group (former group IIIA), wherein the mol-% is based on the oxygen in the oxide B.

4. The process according to claim 1, wherein at least one or all of the following applies to the first powder:
a. comprises at least 25 mol-% yttria;
b. comprises at least 50 mol-% alumina.

5. The process according to claim 1, wherein χ_{α} is in the range from 2 to 9 μm.

6. The process according to claim 1, wherein at least one or all of the following applies:
a. χ_{β} is less than or equal to 0.8 μm, and wherein χ_{β} is larger than 0;
b. q_{β} is less than or equal to 0.045, wherein q_{β} is larger than 0.

7. The process according to claim 1, wherein the particle size distribution D=q(χ) has a third local maximum γ at particle size χ_{γ} with volume density q_{γ}, with χ_{γ}>χ_{β}.

8. The process according to claim 1, wherein the further constituent powder, of the first powder, has a specific surface area that is in the range from 8 to 20 m²/g.

9. The process according to claim 1, wherein the further constituent powder, of the first powder, is an oxide of a group 13 (formerly group 3A) element.

10. The process according to claim 1, wherein the first constituent powder, of the first powder, is an oxide of an element selected from group 3 (formerly IIIB) or group 4 (formerly IVB).

11. The process according to claim 1, wherein the first layer of the layered body has a thickness that is less than or equal to 15 mm.

12. A layered body obtainable by the process according to claim 1.

13. An assembly comprising a layered body according to claim 12.

14. A device comprising an interior volume, the interior volume being bordered by the following device parts:
i. a first punch interior surface of a first punch;
ii. a second punch interior surface of a second punch; and
iii. an interior surface of a die;
wherein:
a. the punches are adapted and arranged to apply a pressure of at least 1 MPa along a compression axis to a target in the interior volume, wherein the target is preferably at least one powder layer;
b. the first punch and the second punch are connected to an electrical power source;
c. the first and second punches comprise at least 50 wt-% carbon, based on the total weight of the punches;
d. the interior volume has a cross-sectional width W of at least 200 mm, wherein the cross-sectional width W is perpendicular to the compression axis;
wherein
the interior volume comprises a first powder, wherein the first powder is a mixture comprising a first constituent powder and a further constituent powder, wherein the first constituent powder and the further constituent powder have different chemical compositions, and wherein the further constituent powder has a particle size distribution D=q(χ) of volume density q over particle size χ, such that
I./ D has a first local maximum α at particle size χ_{α} with volume density q_{α},
II./ D has a second local maximum β at particle size χ_{β} with volume density q_{β},
III./ χ_{α}>χ_{β}, and
IV./ q_{α}/q_{β} is at least 1.

15. Use of a powder, that is a mixture comprising a first constituent powder and a further constituent powder, for producing a layered body that comprises a first layer, wherein
a. the first constituent powder and the further constituent powder have different chemical compositions,
b. the further constituent powder has a particle size distribution D=q(χ) of volume density q over particle size χ, and
c. D has at least two local maxima.
